(19) United States
(12) Patent Application Publication
(10) Pub. No.: US 2024/0127978 A1
(43) Pub. Date: Apr. 18, 2024

(54) METHOD FOR THERMAL PERFORMANCE MONITORING OF A NUCLEAR POWER PLANT USING THE NCV METHOD

(71) Applicant: Fred Donald Lang, SALT SPRING ISLAND (CA)

(72) Inventor: Fred Donald Lang, SALT SPRING ISLAND (CA)

(21) Appl. No.: 17/887,860

(22) Filed: Aug. 15, 2022

Related U.S. Application Data
(63) Continuation of application No. 17/586,033, filed on Jan. 27, 2022, now abandoned.
Application No. 17/586,033 is a continuation-in-part of application No. 17/575,343, filed on Jan. 13, 2022, now abandoned.
Application No. 17/575,343 is a continuation-in-part of application No. 17/300,856, filed on Nov. 30, 2021, now abandoned.
(60) Provisional application No. 63/292,489, filed on Dec. 22, 2021.
(60) Provisional application No. 63/360,510, filed on Oct. 8, 2021.
(60) Provisional application No. 63/360,390, filed on Sep. 24, 2021.

(51) Int. Cl. G21D 3/00; G21C 17/108; G21C 17/112

(52) U.S. Cl. CPC G21D 3/002; G21C 17/108; G21C 17/112

(57) ABSTRACT

This invention relates to the monitoring and diagnosing of nuclear power plants for its thermal performance using the NCV Method. Its applicability comprises any nuclear reactor such as used for research, gas-cooled and liquid metal cooled systems, fast neutron systems, and the like; all producing a useful output. Its greatest applicability lies with conventional Pressurized Water Reactor (PWR) and Boiling Water Reactor (BWR) nuclear power plants generating an electric power. Its teachings of treating fission as an inertial process, a phenomena which is self-contained following incident neutron capture, allows the determination of an absolute neutron flux. This process is best treated by Second Law principles producing a total fission exergy. This invention also applies to the design of a fusion thermal system regards the determination of its Second Law viability and absolute plasma flux.

### CROSS-REFERENCE TO RELATED APPLICATIONS

This application is being filed as a Continuation-In-Part of U.S. Utility application Ser. No. 17/586,033 ('033) filed Jan. 27, 2022. '033 was filed as a Continuation-In-Part of U.S. Utility application Ser. No. 17/575,343 ('343) filed Jan. 13, 2022. '343 was filed as a Continuation-In-Part of U.S. Utility application Ser. No. 17/300,856 ('856) filed Nov. 30, 2021. '033, '343 and '856 are hereby incorporated by reference in their entireties and for all purposes. '343 was also filed claiming priority benefits under Title 35 USC 119(e) of U.S. Provisional Application 63/292,489 ('489) filed Dec. 22, 2021. '856 was also filed claiming priority benefits under Title 35 USC 119(e) of U.S. Provisional Applications 63/360,510 ('510) filed Oct. 8, 2021and 63/360,390 ('390) filed Sep. 24, 2021. These Provisional Applications '489, '510 and '390 are incorporated herein by reference in their entireties and for all purposes.

### COPYRIGHT NOTICE

A portion of the disclosure of this patent document contains material which is subject to Copyright protection. The Copyright owner has no objection to the facsimile reproduction by anyone of the patent document or the patent disclosure, as it appears in the Patent and Trademark Office patent file or records, but otherwise reserves all Copyright rights whatsoever.

### BACKGROUND OF THE INVENTION

### Field of the Invention

This invention relates to the monitoring and diagnosing of nuclear power plants resulting in a set of verified “Thermal Performance Parameters” (defined below) using a NCV Method. Its applicability comprises any nuclear reactor such as used for research, gas-cooled and liquid metal cooled systems, fast neutron systems, and the like; all producing a useful output. Its greatest applicability lies with conventional Pressurized Water Reactor (PWR) and Boiling Water Reactor (BWR) nuclear power plants generating electric power. Its teachings of treating fission as an inertial process, a phenomena which is self-contained following incident neutron capture, allows the determination of an absolute neutron flux. This process is best treated by Second Law principles producing a total fission exergy. This invention also applies to the design of a fusion system regards a determination of its Second Law viability and the computation of an absolute plasma flux.

Description of Related Art

Nuclear engineering methods have evolved since the 1940s into a discipline in which certain nuclear parameters are computed with a greater accuracy than may be directly measured. Examples comprise: conversion of a Δmass to Δenergy (ΔE=c²Δm); MeV/fission values by fissile nuclide; antineutrino creation given β⁻ radiation after neutron decay; cross section Doppler broadening given temperature affects; neutron diffusion theory including diffusion length; affects on neutron flux of control rod movement; nuclear generated decay heat after shutdown; etc. These parameters, having high accuracy, are computed by the nuclear engineer using established art. However, an area in which nuclear engineering is weak is determination of an absolute neutron flux present in large power reactors. There are three reasons for this weakness. The first reason is that the nuclear engineer only cares about a change in flux; e.g., an exponential increase is an obvious concern regards prompt criticality. To obtain a desired thermal load, the light water reactor operator simply moves a control rod, thereby changing flux and fission rate. A second reason for not emphasizing absolute flux is the difficulty in direct measurement. Typical reactor operations will see many orders of magnitude change in neutron flux from startup to full power. Flux in a power reactor will exceed 10^{12 1}n₀-cm⁻²-sec⁻¹. The long-time practice is to employ fission chambers placed at the reactor's boundary, which are influenced by the local (leakage) neutron flux. Such chambers measure ionized radiation produced by fission. Periodically, given the consumption of fissile material, they are replaced. These instruments produce a relative measurement, whose signal requires normalization to an assumed average flux as a function of burn-up. A third reason lies with the fundamental neutron diffusion theory. Diffusion theory describes the shape of the flux, it does not solve for its magnitude. Given finite dimensions, the radial or axial shape is resolved based on boundary conditions. In the axial direction of a finite cylinder of fissile material, a symmetric cosine shape is assumed. For a PWR and BWR, there is no known art which does not assume a symmetric, theoretical, trigonometric function (e.g., cosine) centered about the cylinder.

Another area involving a lack of discipline, indeed a classic lack, is the measurement of fluid flow in large pipes. A PWR circulates water in its primary flow loop (circulating water through the reactor, liberating its energy flow in a “Steam Generator”, SG). A secondary PWR loop circulates water through a conventional Regenerative Rankine cycle (the “Turbine Cycle”, TC). A BWR circulates water through the reactor and then directly to the conventional Regenerative Rankine cycle. The typical nuclear power plant employs coolant pipes, which, for a 600 MWe unit and above, are greater than 30 inches in diameter. Flows in a PWR or BWR Reactor Vessel (RV) typically exceed 100 million lbm/hr. The most commonly used flow instruments are non-invasive, such as ultrasonic. Ultrasonic measured flows, and indeed any measurement from a non-direct instrument, must be normalized as they are relative indications. For those pipes which are small enough (say less than 18 inches in diameter), flow nozzles specified by the American Society of Mechanical Engineers (ASME) have been employed. Of course, mass flows are deduced from thermodynamics balances based on assumed nuclear thermal power, etc. System errors using such assumptions have been stated to this inventor as between ±3 to ±5%. At least one vendor of ultrasonic flow measurements quoted ±0.35% error regards RV flow. However, without an established nexus between flux and flow with verification, no cited accuracy has meaning

There is no monitoring system, including any analytical diagnostic method, associated with a nuclear power plant which addresses the whole system in a comprehensive manner—that is nexus, for example, between calculable nuclear parameters and Turbine Cycle feedwater flow, and with proof of results. There is no system which relates absolute neutron flux to reactor coolant flow, to water flow through the Turbine Cycle, to gross electrical generation . . . and provides demonstrable accuracy. Such a monitoring system and its supporting method of diagnoses is needed for the Nuclear Steam Supply System (NSSS or NSS System).

The idea of results verification associated with thermal performance monitoring of power plants, although new when applied to nuclear power plants, is not new when applied to fossil power plants. This inventor has been granted a number of patents related to understanding fossil-fired systems and associated verification teachings. Although none of these patents relate to nuclear power, one of their teachings has been modified for this invention. The important relevant teachings are found: in U.S. Pat. No. 7,328,132 issued Feb. 5, 2008; in U.S. Pat. No. 7,809,526 issued Oct. 5, 2010; and in U.S. Pat. No. 6,714,877 issued Mar. 30, 2004 (hereinafter '132, '526 and '877). '132 and '526 contain the same relevant section entitled “Correction of Choice Operating Parameters and System Benchmarking” starting on Col. 44 in '132, and starting on Col. 42 in '526. '877 teaches the determination of correction factors associated with fossil-fired power plants applied to measured gaseous effluents and other parameters associated with fossil combustion. This same technology appears in several related non-US patents: Canadian 2,541,197 & 2,754,638; European 1,835,228 (GB, DE, IE, CH); and Australian 2006-201, 203. In addition to these patents, another invention, important to this invention, describes how to synchronize data originating from different sources, each source having a different time reference. This synchronizing invention is described in U.S. Pat. No. 6,810,358 issued Oct. 26, 2004 (hereinafter '358). Note that one application of technology taught in '132, '526, '877 and '358 resulted in winning ASME's prestigious Prime Mover's Award.

It must be emphasized that the inventor's prior technologies of '132, '526 & '877, and the teachings herein, do not employ “statistically-based” methods as applied thermodynamically. Statistically-based methods as defined herein comprise: neural networks; artificial intelligence; fussy logic; pattern recognition; data interrogation; application of corrective functions (e.g., manufacturers curves); and other such techniques. Simply stated, statistically-based methods would claim to benefit the thermodynamic understanding of any system through signal manipulation. It is believed that statistically-based techniques have had a flash-in-the-pan repetition in the power industry and presently see little use. Whether presently used or not, the reason for failure of these methods, when applied to complex thermal systems includes: assumptions of linearity among system variables; the lack of computational closure regarding the First and Second Laws as applied to the system; and the lack of verification.

Regarding assumptions of linearity, note that an 800 MWe power plant monitors >40,000 signals. Some signals are quite minor in importance, some are very important. Given massive data streams—coupled with thermal systems those thermodynamic properties of water comprise subcooled, saturated, superheated and (possibly) supercritical regions, all non-linear, involving pressure, temperature or quality, and flow measurements, with material heat losses, etc.—the idea of accurately forming variance-covariance matrixes required for many of the statistically-based methods is simply not rational. Resolution of coefficients comprising variance-covariance matrixes for power plants has nowhere been propagated.

Such use invokes a variance-covariance matrix used for tolerances, but such a matrix is never provided. Power plants are simply too complex to assume otherwise. For example, turbine vendors do not specify the tolerance range acceptable for piece-wise corrections when using their curves. Such use invokes a variance-covariance matrix used for tolerances, but are never provided. Critical to statistically-based methods is that measurement distributions are multivariate normal. Corrections based on manufacturer's curves are hardly statistically normal.

Many organizations employ statistically-based methods claiming to improve the accuracy of computed system-wide results (e.g., system thermal efficiency). Statistically-based techniques include those offered by: NeuCo of Boston, MA a subsidiary of General Electric Company; ScienTech LLC of Idaho Falls, ID a subsidiary of Curtiss-Wright Corporation; STEAG Energy Services GmbH of Essen, Germany a subsidiary STEAG GmbH; the VISTA program believed to be owned by the Electric Power Research Institute of Palo Alto, CA, marketed by Black & Vetch of Kansas City; General Physics Corporation of Columbia, MD a subsidiary of GP Strategies Corporation; and similar offerings.

Regarding the lack of satisfying the laws of thermodynamics, simply stated, if statistically-based techniques could adjust multiple parameters consistent with the laws of thermodynamics, then why don't they simply make First and/or Second Law balances? None are known to do so. If said adjustments could be applied to a single parameter, it would be inconceivable that such a parameter would be so chosen, and adjusted in just the correct manner to then satisfy the Laws for a complex system (all other parameters assumed absolutely constant); and, further, to then serve for positive verification. On the other hand, if a number of parameters are addressed there is no method—other than thermodynamically based—which would then achieve closure of a system-wide balance.

No known statistically-based technique employs any means by which results can be verified. Verification means satisfying the laws of thermodynamics assuming a system-wide boundary by comparing computed parameters with the known. It means choosing a computed parameter, which is derived directly from thermodynamic balances, and is then verified (compared) to an accurately measured, or accurately known standard. For example, '132 & '526 teach verification of fossil-fired techniques. One of these involves the combustion path's water balance as based on conservation of stoichiometrics. A “known” soot blowing flow (i.e., steam flow used to clean heat transfer surfaces) should be back-calculated and comparable to the directly metered. If one cannot verify such a water balance, then one does not understand a hydrogen balance, nor an oxygen balance, etc. required for First Law balances. Thus the computation of fossil Steam Generator efficiency, using such flawed data, becomes ludicrous.

There are two keys aspects to '132, '526 and '855 technologies. First, a set of operating variables is chosen, which can be altered to known standards; a difference (the operating variable less its standard) is driven to zero, Δλₖ→0.0. A fossil example is use of the L₁₀ parameter descriptive of an unique coal's chemistry. This is achieved for the set of operating variables by adjusting another set of chosen variables (a secondary set, Λₘ) whose absolute accuracy is questionable, but given adjustments, drives the set of operating variables to resolution. Λₘ may be an effluent concentration of CO₂ which affects computed coal chemistry. Adjustments are made via correction factors to the concentration until the computed value and its reference (L₁₀) are matched. Second, after resolution of Δλₖ, verification of system-wide, thermodynamic understanding is made without use of statistically-based techniques. Hitherto, no such technique has been applied to a nuclear power system.

When considering Thermal Performance Parameters of NSS Systems, two historic and distinct categories of prior art require discussion, they are both clearly in need of modifications when applied to the NSSS. The first category consists of both classic First Law efficiencies, and Second Law methods involving both effectivenesses and established art based on Fuel Consumption Indices used for monitoring fossil-fired units whose technology is needed for nuclear power. What is true regarding verified understanding of the fossil-fired unit, which served as the basis for Fuel Consumption Indices, also applies to the nuclear power plant if properly developed. Indeed, computing accurate First & Second Laws NSSS parameters requires understanding the complete system—that is, a nexus between neutron flux and Balance-of-Plant (BOP) parameters which, to date, has never been accomplished.

Fuel Consumption Indices have been used for 20 years to improve understanding of fossil-fired power plants (hereinafter termed FFCI). References for FFCI technology can be found in U.S. Pat. No. 6,799,146 issued Sep. 28, 2004, starting Col. 5 (hereinafter '146). Another reference is F. D. Lang, “Fuel Consumption Index for Proper Monitoring of Power Plants—Revised”, ASME Conference, IJPGC 2002-26097, Jun. 24-26, 2002. However, no reference, nor any patent issued to this inventor, teaches FFCI technology applied to nuclear power plants. Thus new art is required to understand the fission phenomenon, in a thermodynamic context, coupled with associated irreversible losses. Established art teaches the following for a fossil-fired system (terms defined below).

G_{IN}=P_{GEN}+ΣIₖ (1BG)

where ΣIᵢ, as taught for fossil-fired systems, is defined as:

ΣIₖ=∫(1.0−T_{Ref}/Tₖ)∂Qₖ−∫∂Pₖ−∫[mdg]ₖ (2BG)

The total exergy flow supplied (G_{IN}) for a fossil-fired system comprises exergy flows for combustion air, in-leakages, shaft powers supplied (pumps), and a fossil fuel's exergy flow. The fossil fuel's exergy flow requires great computational complexity. The nuclear system brings its own unique complexities. '146 assumed pump shaft power is taken as the fluid's increased energy flow, mΔh; this, less an exergy flow mΔg, results in a [T_{Ref}Δs] loss. NSS System's pumps are unusually large, requiring additional detail. After determining G_{IN} and ΣIₖ, Fuel Consumption Indices are formed by simply dividing Eq.(1BG) through by G_{IN}, and then multiplying by 1000 for numerical convenience :

1.0=P_{GEN}/G_{IN}+ΣIₖ/G_{IN} (3BG)

1000=FFCI_{power}+ΣFFCI_{Loss-k} (4BG)

where FFCIs are then self defined, converting P_{GEN} to electrical output P_{UT} with losses:

FFCI_{Power}≡1000[3412.1416 (P_{UT}+L_{Mech}+L_{Elect})]/G_{IN} (5BG)

FFCI_{Loss-k}≡1000 Iₖ/G_{IN} (6BG)

Eqs. (1BG) & (4BG) state: 1) G_{IN} exergy flow is “destroyed” by generating only useful power and irreversible losses; and 2) if any FFCI decreases, the operator is assured that commensurate increases are inherently identified, Eq.(4BG) will always sum to 1000. If FFCI_{Power} decreases, one or more identified FFCI_{Loss-k} terms must increase (and thus are located within the system).

The second category of Thermal Performance Parameters uniquely addresses that NSSS core power is limited by regulatory authorities in many countries. For an operating NSSS in the U.S., regulation 10CFR 50.36 Technical Specification, lists the licensed power limit which cannot be exceeded. This licensed power limit is herein defined as the “Regulatory Limit”. “Core Thermal Power” (CTP) is a term used by the nuclear industry throughout the western world to refer to power generated from the reactor core without pump contribution. This phrase does not appear in 10CRF. However, in agreement with 10CRF50 usage, it is defined herein as meaning:
Core Thermal Power is that power exclusively generated by nuclear fuel, taken as the difference between the energy flow leaving the Reactor Vessel less the energy flow input to the Reactor Vessel, accounting for non-nuclear Reactor Vessel energy flows.

In summary, measures must be taken such that CTP produced by a nuclear power plant does not exceed the Regulatory Limit. Given the very high Reactor Vessel coolant mass flow in large pipes, discussed above, current practice is to determine CTP based on a First Law energy flow balance of the Turbine Cycle, only then making transference to the Reactor Vessel and its core power. Currently the industry has no method of determining and verifying RV mass flow. Such computations assume that an acceptable operational tolerance is ±2.0%; i.e., CTP may drift ±2.0% from its average value, but must not exceed the limit. This operational tolerance is herein defined as the “Operating Tolerance Envelope”. Thus the industry is allowed a misunderstanding of NSSS operations with a 4% band; this is institutionally unsafe. A −2% unclaimed electric power for a 1000 MWe NSSS exceeds $15 million/year; over a 40 year NSSS life, the loss in gross revenue exceeds $0.6 trillion. A more accurate method of computing CTP, and a reduction in the currently acceptable Operating Tolerance Envelope (e.g., from ±2.0%) are clearly required by the industry.

If the CTP Regulatory Limit is never to be exceeded, fission must be controlled; this typically requires fine adjustments by the operator when nearing the limit, or staying within a reduced Operating Tolerance Envelope. In 1943 the CP1 experiment established the framework for controlling a nuclear reactor; much of its techniques and terminology survives to this day. CP1 resulted in the first nuclear reactor patent, U.S. Pat. No. 2,708,656 (hereinafter '656), as issued to Enrico Fermi and Leo Szilard on May 17, 1955; it was filed on Dec. 19, 1944 and corrected on Jul. 26, 1955 for spelling errors. If read, '656 Col. 18, Lines 74-75, states: “Construction [of CP1] is continued with the shim rod, control rod and safety rods fully inserted into the reactor . . . ”. '656 discusses these control mechanisms throughout. Its terminology is employed herein: for safety shut-down, for “shim” to achieve course adjustments, and for “controlling” to achieve fine adjustments by the operator.
“Safety Mechanisms” cause a complete shut-down of flux induced fission, resulting in a ≈zero power condition;
“Shim Control” affords course control of the fission rate over an extended period of time (typically 1 to 3 month periods); and
“Controlling Neutron Density” (hereinafter CND) is herein defined as any mechanism which is instigated by the operator which changes the core's neutron density, typically instigated to achieve fine adjustment to the core's neutron density.

For the traditional PWR, boric acid (H₃BO₃) fluid is added to the coolant when required for shut-down. It is also used in PWRs for Shim Control by varying its concentrations slowly, or step-wise, over time (e.g., every month). For the traditional BWR sodium pentaborate (Na₂O·5B₂O₃) fluid is used as a Safety Mechanism. For the PWR & BWR, to extend fuel life, Shim Control includes permanently installing rods containing Burnable Absorbers positioned axially (e.g., Gd₂O₃, U₃Si₂, elemental B, Hf, Cd, Ag, In and other absorbers). For BWR Shim Control can also involve repositioning control rods at one to three month intervals. For the modern NSSS CND means the operator will engage physical mechanisms which alter the “Thermal Utilization Factor” (TUF); typically to achieve fine adjustments. For the light water reactor, changing TUF means moving control rods (neutron absorbers) and/or altering core flow to change the volume of voids present in the coolant channels. For any operating reactor, the one neutronic parameter which can be directly influenced by the operator through CND, is the TUF. TUF is defined as the ratio of the number of neutrons absorbed in the fuel versus the total number of absorptions in the core; i.e., in the fuel, moderator, structural materials and designed mechanisms for Controlling Neutron Density (e.g., control rod movement and/or changes in core flow).

The NRC requires all U.S. power reactors to be designed with a negative Void Coefficient of Reactivity (VCR). VCR is defined as the change in reactivity per percent change in the void volume. A negative VCR means as the void volume increases, fission rate decreases through design. For the traditional PWR, VCR has no influence on routine control; CND is instigated by the operator by moving control rods. Obviously when control rods are withdrawn, a higher neutron density is achieved and thus higher CTP; when inserted, lowered neutron density results and lower CTP. PWR control rods are metallic, movable in the axial, comprising an alloy of 80% silver, 15% indium, 5% cadmium. Consideration of the VCR for BWR control is obviously important as it is directly affected by CND. For the typical BWR, CND is instigated by the operator by changing recirculation flow in the core, in conjunction—for some designs—with moving control rods. When controlling through recirculation, mass flow delivered to the Reactor Vessel does not necessarily change. An increased core flow suppresses boiling given additional heating is required for saturation. The Departure from Nucleate Boiling (DNB) position moves upward, the void volume decreases. The resulting increase in reactivity, increases core power; this continues until the DNB boundary and the void volume are restored and core reactivity returns to unity, given an overall negative VCR. The reverse mechanism occurs when decreasing recirculation, resulting in a lower CTP. In both cases, void volume changes are transient in nature, eventually returning to near design levels with an altered recirculation flow and CTP. However, there are a number of BWR control mechanisms. BWR have been designed with recirculation flow controlled using variable speed pumps, flow control values, and/or jet pumps those motive flow is delivered via RV pumps. For other BWRs CND is achieved via direct control rod movement without changes to core flow. BWR control rods typically comprise boron carbide (B₄C) and/or hafnium (Hf).

Although the above descriptions of reactor control—safety, shim, control—has been described for the typical light water reactor, other embodiments within the scope and spirit of the present invention are possible without departing from the general industrial applicability of the invention. The definition of CND is to be taken generically; as examples: a PWR control rod could employ boron carbide for its CND, or fast injection of boric acid directly into the core is an applicable CND. Also, although negative VCR are a feature of U.S. designed power reactors and the Advanced CANDU, positive VCR are featured in the CANDU, Soviet RBMK and most LMFR. Graphite moderated, gas cooled and pebble bed reactors have zero VCR. Control of nuclear reactors, of any design, is fundamentally to instigate Controlling Neutron Density.

In summary, to increase Core Thermal Power the operator will increase neutron density, thereby increasing TUF (e.g., CND means control rods are withdrawn, and/or coolant recirculation in th core is increased); to decrease Core Thermal Power the operator decreases neutron density, thereby decreasing TUF (e.g., CND means control rods are inserted, and/or coolant recirculation is decreased).

In describing the power derived from CP1, Fermi understood that it was directly related to the MeV release from fission (he assumed 200 MeV/Fission) and a neutron flux based on in-core irradiated foils. In '656, Col. 21, Lines 55-74, he correctly computed core power as:

Power=f[200 MeV/Fission, Φ_{TH} (Indium foil radioactivity)] (7BG)

Although CP1 was convectively cooled, its graphite moderated design was upscaled to the first plutonium production X-10 Pile at Oak Ridge and then later to the N Reactor at Hanford. Ratings of both were assessed only in terms of thermal power; they required river cooling of 4 and 4000 MWt respectively. In Fermi's 1937 text on thermodynamics, he enhanced Gibbs' free energy principals by developing a thermodynamic “potential” (a form of availability). System potentials and exergy (termed thermodynamic availability) were being studied at this time, fully defined by 1941. Given this background, it is remarkable that Fermi did not translate his core power, indeed, a correct nuclear G_{IN}, to a change in the coolant's \dot{m}Δg (or like parameter), versus \dot{m}Δh. See E. Fermi, Thermodynamics, Dover Publications, Garden City, NY, 1956, Chapter V, first published 1937.

A long-standing issue in the commercial nuclear power industry is so-called “NVT Damage”. It has been observed that a neutron flux will disrupt molecular structures, including building materials, caused by neutron scattering phenomenon. Such damage is dependent on the intensity and magnitude (N) of the flux, and the velocity (“energy”) distribution of the flux (V), and the time of irradiation (T). To monitor NVT Damage, material samples (steel and the like) are placed in capsules called “coupons” and placed throughout the Reactor Vessel for later retrieval and analyses. Although the distribution of neutron flux maybe understood; such distribution tells nothing of its magnitude, whose uncertainty is high. What is needed is an method of determining the absolute magnitude of the average flux, by which a distribution as a function of “energy” and time may be determined; this information being useful for maintenance predictions and end-of-RV-life predictions.

Again, what is required to improve the first category of prior art for NSSS thermal performance monitoring, is an improved understanding of the system, an analytical model offering nexus between neutronics and system thermodynamics, with embedded verification. Needed is the development of Second Law FFCI-type analyses which is highly amenable for rapid identification of degraded components within the system; thus a “Fission Consumption Index” (FCI) requires development.

### BRIEF SUMMARY OF THE INVENTION

This invention relates to any nuclear system producing a useful output (e.g., a steam flow exiting the system and/or production of electric power). This invention especially relates to large, commercial PWRs and BWRs, producing a shaft energy flow leading to the production of electricity. The invention comprises the computation of power derived directly from the fission process using a average neutron flux and computed neutronic parameters. Thermal power is independently developed from thermodynamic balances, mass and energy flow balances associated with the Turbine Cycle's (TC) working fluid, and the like. Such balances, using First and/or Second Laws of thermodynamics, as detailed in the SPECIFICATION, is termed its calorimetric Model. This disclosure teaches how the exergy flow from fission and the commensurate energy flow to the TC can be: 1) intrinsically related and 2) verified in real-time . . . thus establishing nexus between nucleonics & plant data, and calorimetrics. Nucleonics & plant data (N) and calorimetrics (C) form a system of equations, their resolved unknowns confirmed using a set of “Verification Procedures” (V), defined below. This is the “NCV Method”. When on-line, the NCV Method produces a set of verified Thermal Performance Parameters which are used by the operator for improved monitoring.

Temporal data over a typical fuel cycle is required from fuel management computations comprising number densities and cross sections of fissile isotopes as a function of energy and burn-up. Static data required comprises: mechanical design of fuel pins, fuel assemblies and structural components; MeV/fission data; core volumes of the fuel, structure and coolant (moderator); and number densities at start-up (a virgin reactor core). Note that recoverable MeV/Fission data is well known. Measurements in real-time are required on the coolant-side for determining thermal energy flow to the Turbine Cycle (TC). Such data comprises: pressures, temperature or quality and indicated mass flows; gross electrical generation; and other routine TC data.

With such temporal and static data, with calorimetrics, a matrix solution is solved which resolves declared unknowns comprising: NSSS useful output (e.g., electrical generation) based on the computed shaft power delivered to the electric generator; average neutron flux ; TC condenser energy flow rejection; and Reactor Vessel coolant mass flow. As discussed, there are few parameters associated with a nuclear power plant which can be measured with high accuracy. Important parameters such as primary fluid mass flows, neutron flux and the Used Energy End Point (UEEP) associated with the low pressure turbine exhaust are examples of parameters which cannot be directly accessed without system solution. A critical exception of a parameter which is known with high accuracy is the measured electric power. NCV technology takes electric power as a declared unknown. The NCV's matrix solution, having solved for the computed electric power, then compares this value to the directly measured, driving Δλₖ→0.0. Although this direct comparison of electric power is prima facie verification and having great import, other verifications involve comparing the computed with the measured, including examining parameter trends over time. For example, after detailed benchmark testing of the Turbine Cycle, demonstrating that the indicated feedwater flow is consistent (perhaps not accurate), a computed feedwater flow (based on reactor flow) must then track changes with the indicated signal. Similar trackings comprise: computed flux versus the fission chamber signal; computed Reactor Vessel flow with the plant indicated; also trends in the computed antineutrino (and possibly neutrino) as a portion of total MeV/Fission exergies; computed condenser rejection versus changes in condenser pressure; etc.

This invention teaches the use of statistical methods, not to directly affect thermodynamic computations nor any measured value, but rather to simply determine correction factors applied to user selected parameters which in turn produce computational closures (Δλₖ→0.0, i.e., resolution of a declared unknown). For example, computed electric power is obviously affected by NSSS energy balances. When applying the Second Law to resolve individual NSS Systems, neutron flux is the driving quantity. Neutron flux is responsible for fission, fission produces the recoverable and unrecoverable exergies (e.g., fission fragments, radiation and antineutrinos). Although antineutrinos (and possibly neutrinos) will lose their exergies only after passing through a light-year thickness of lead, if excluded, the Second Law's irreversible losses would carry error and certainly given virgin fission (i.e., an un-irradiated fuel). The Mev/Fission contribution assigned to the antineutrino (or neutrino), must appear both as a portion of the total exergy supplied and as an irreversible loss. As taught using the NCV Method, antineutrino (or neutrino) terms appear both as a portion of exergy supplied, and as an irreversible loss. Without such treatment of irreversible losses, neutron flux will be in error. Upon resolution, such an antineutrino (or neutrino) loss as a computed output, must lie within an established range. When computed within the established range, it serves, in part, the set of Verification Procedures.

### BRIEF DESCRIPTION OF THE DRAWINGS

FIG. 1 is a representation of a PWR. Included in FIG. 1 is a representation of the data acquisition system as required to implement the NCV Method.

FIG. 2 is a representation of a BWR. Included in FIG. 2 is a representation of the data acquisition system as required to implement the NCV Method.

FIG. 3 is a representation of the Pseudo Fuel Pin Model used to couple the axial neutron flux to the exergy flow delivered to the coolant using an average fuel pin and its average coolant flow.

FIG. 4 is a block diagram of the NCV Method showing the flow of computer logic, including the two principal computer programs employed by NCV: NUKE-EFF and NUKE-MAX.

FIG. 5 is based directly on computations associated with the Pseudo Fuel Pin Model consisting of: an Clausen Function profile associated with a normalized, axial, neutron flux profile; results of an axial exergy rise through the core based on a cosine-based flux profile; and results of an axial exergy rise through the core based on the Clausen Function profile.

### DETAILED DESCRIPTION OF THE INVENTION

To assure an appropriate teaching, the NCV Method and its associated apparatus are divided by the following sub-sections. The first two present Definitions of Terms and Typical Units of Measure, and the Meaning of Terms (such as “Choice Operating Parameters” and “System Effect Parameters”). The remaining sub-sections, representing the bulk of the teachings, are divided into: NS S S Thermal Powers and Efficiencies; Neutronics Data; Fission Consumption Indices; Pseudo Fuel Pin Model; and Resolution of Unknowns and Optimization. This DETAILED DESCRIPTION section is then followed by the important INDUSTRIAL APPLICABILITY section containing sub-sections of: The Calculational Engine and Its Data Processing; Clarity of Terms; Final Enablement; and Detailed Description of the Drawings.

### Definitions of Terms and Typical Units of Measure

### Nuclear Terms:

B_{P}²=Nuclear pseudo-buckling used in the PFP Model; cm².
C_{FLX}=Correction factor applied to the indicated Fission Chamber's flux, used in Eq. (62); unitless.
C_{dv}=Limitation constant on the highest possible neutrino loss, v̅_{TNU}(t); unitless.
C_{M}=Uncertainty in the neutron migration length, +ΔM_{T}; cm.
C_{MAX}=Defined by TABLE 2 and related teachings regards conversion between Φ_{TH} and Φ_{MAX}, examples include the cosine function C_{MAX-CO} and Clausen Function C_{MAX-CL}; unitless.
C_{φν}=Limitation variance on the computed Φ_{TH}(t) reduced from leakage terms; unitless.
k=Neutron multiplication coefficient; unitless.
k_{B}=Boltzmann's constant; 4.787407×10⁻¹¹ MeV/° R.
k_{EFF}=Neutron multiplication (reactivity) coefficient; unitless.
M_{FPin}=Number of fuel pins heating the core's coolant; unitless.
M_{TPin}=Number of total fuel pin cells available for coolant flow within the core; unitless.
M_{T}²=Thermal neutron migration area (M_{T} is the diffusion length plus √Fermi Age); cm².
Nⱼ=Number density of isotope j; (number of j)/(barn-cm).
Q_{TNU}=Total antineutrino (and possibly neutrino) exergy flow from fission, same as Q_{NEU-Loss}; Btu/hr.
Q_{REC}=Recoverable exergy flow from fissile materials; Btu/hr.
V_{Fuel}=Volume of nuclear fuel consistent with macroscopic cross sections; cm³.
Ξ(T_{Ref})=Inertial Conversion Factor, defined by Eq. (5); unitless.
ν_{XXX-j}=Exergies from fissile isotope j, see TABLE 1 for XXX; MeV/Fission.
v̅=Average fission exergy release, weighted by fissile isotope; MeV/Fission.
Σ=Summation of terms.
Σ_{F-j}=Macroscopic fission cross section for fissile isotope j; cm⁻¹.
σ_{F-j}=Microscopic fission cross section, isotope j; barn.
τ̅=Mean age of thermal neutrons given a fission spectrum, the Fermi Age; cm².
Φ_{FC}=Thermal neutron flux at fission chamber; ¹n cm⁻² sec⁻¹.
Φ_{MAX}=Maximum theoretical flux associated with a cosine or Clausen profile; ¹n cm⁻² sec⁻¹.
Φ_{TH}=Average neutron flux satisfying NCV calorimetrics, ¹n cm⁻² sec⁻¹.
Ψ_{LRV}Φ_{TH} v̅_{LRV}(t) , irreversible loss regards the antineutrino and/or neutrino; MeV/cm²-sec-Fission.

### System Terms:

C_{P-j}=Ratio of a CD pump flow (j) to final Feedwater flow; mass ratio.
C_{FW}=Correction factor applied to the indicated TC feedwater mass flow, used Eq. (65); unitless.
C_{RV}=Correction applied to the indicated RV coolant mass flow, used in Eq. (66); unitless.
FCIₖ=FCI for the k^{th} (irreversible) process; unitless.
FCI_{Power}=FCI for the power production process; unitless.
g≡(h−h_{Ref})−T_{Ref}(s−s_{Ref}), specific exergy (also termed “available energy”), this definition is applicable for inertial processes; Btu/lbm.
G_{IN}=Total exergy flow supplied to a NSSS; Btu/hr.
h_{Ref}=Reference enthalpy for exergy: f(P_{Ref}, x=0.0); Btu/lbm.
Iₖ=Irreversibility of process k; Btu/hr
L_{Elect}=Generator electrical losses, variable f(P_{GEN}); KWe.
L_{Mech}=Generator mechanical losses, fixed f(P_{GEN}); KWe.
m=Mass flow of fluid, also termed \dot{m}; lbm/hr.
mΔg=Exergy flow; Btu/hr.
mΔh=Energy flow; Btu/hr.
MC_{Λm}=Dilution Factor for COP Λₘ used in Eq. (67); unitless.
P_{FWP-Aux}=Credit energy flow from an Auxiliary Turbine delivered to a Feedwater pump, Btu/hr.
P_{GEN}=Shaft power delivered to the electric generator; Btu/hr.
Pᵢᵢ₋ₖ=Motive power delivered to individual pump k (ii=RV, TC or CD); Btu/hr.
P_{Ref}=Reference saturation pressure for exergy: P_{Ref}=f(T_{Ref}); psiA.
P_{UT}=Gross measured electric power at the generator terminals; KWe.
Q_{REJ}=Energy flow rejected at the TC's Condenser; Btu/hr.
Q′_{RV}=Net exergy flow from the RV to SG, including pump powers and vessel loss; Btu/hr.
Q′_{RVQ}=Core Thermal Power, an energy flow; Btu/hr.
Q_{SG}=Net energy flow delivered to PWR's SG from the RV or directly to the BWR's TC; Btu/hr.
Q_{TC}=Net energy flow delivered to the Turbine Cycle including pump power; Btu/hr.
Q_{RV-Loss}=Vessel insulation losses from the RV, given T_{RVI} transfer temperature; Btu/hr.
Q_{SG-Loss}=Vessel insulation & miscellaneous losses from SG, given T_{FW} transfer temperature; Btu/hr.
Q_{TC-Loss}=Miscellaneous equipment insulation TC losses (turbine casing, FW heaters, etc.); Btu/hr.
r₀=Outside radius of the fuel pellet, for the PFP Model; cm.
r=Outside radius of the core, the assumed location of fission chambers (r_{FC}); cm.
s_{Ref}=Reference entropy for exergy: f(P_{Ref}, x=0.0); Btu/R-lbm.
T_{Ref}=Reference temperature for Second Law analyses, defined by Eq. (5); ° F. or ° R.
x=Steam quality; mass fraction.
y=Axial distance from the active core's entrance (PFP's fluid entrance); cm.
Z=Half-height of the active core at temperature; cm.
z=Axial distance from the core's (and PFP's) centerline; cm.
ϵ=Second Law effectiveness; unitless.
η=First Law efficiency; unitless.
Λₘ=Choice Operating Parameter; local units.
Δλₖ=Difference between System Effects Parameter, k, and its reference value; local units.

### Subscripts and Abbreviations:

CD=TC's Condensate System, typically between the Condenser and Deaerator.
CDP=Pump in the Turbine Cycle's Condensate System.
CN=Turbine Cycle's Condenser.
CIP=Circulating pump associated with a BWR, typically contained within the RV.
FCI=Fission Consumption Index.
FWP=Feedwater pump.
NFM=Nuclear Fuel Management.
NSSS or NSS System=Nuclear Steam Supply System (comprising a RV with its TC).
PFP=Pseudo Fuel Pin Model.
RV=Reactor Vessel, referring to a boundary condition encompassing primary pumps.
RVP=Reactor Vessel pump.
TC=Turbine Cycle.
SG=A PWR's Steam Generator.

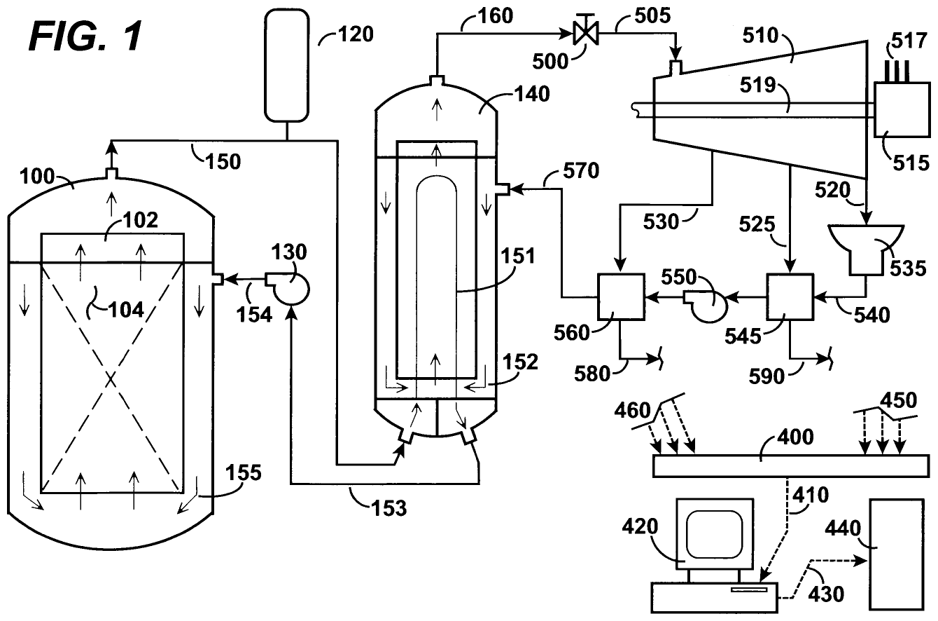

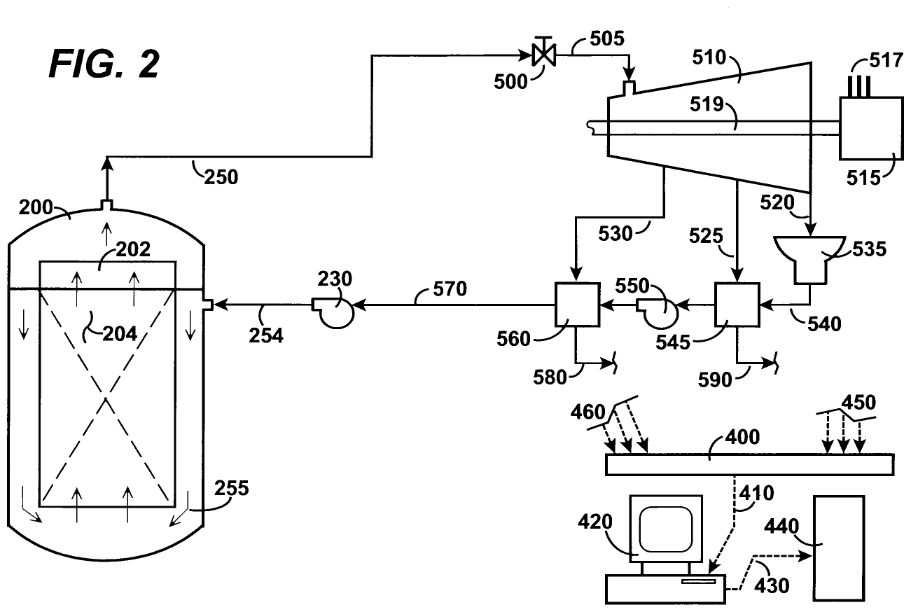

The following subscripts are associated with fluid enthalpy or exergy [e.g., h_{RVI}=Inlet enthalpy to RV]:
CNI=Condenser tube-side inlet.
FW=Final feedwater, FIGs. 1 & 2 start of Item 570.
RCI=Reactor coolant fluid inlet to core, FIG. 1 Item 155 or FIG. 2 Item 255.
RVI=Reactor Vessel inlet nozzle, FIG. 1 end of Item 154 or FIG. 2 end of Item 254.
RVU=Reactor Vessel outlet nozzle, FIG. 1 start of Item 150 or FIG. 2 start of Item 250.
SCI=Steam Generator TC-side coolant fluid inlet to tube bank, FIG. 1 Item 152.
STU=Steam Generator TC-side coolant fluid outlet, FIG. 1 start of tem 160.
SVI=Steam Generator reactor-side inlet nozzle, FIG. 1 end of Item 150.
SVU=Steam Generator reactor-side outlet nozzle, FIG. 1 start of Item 153.
TH=Inlet to TC Throttle Valve, FIGs. 1 & 2 Item 500.

The following subscripts relate differences between quantities (e.g., Δh_{TCQ}=h_{TH}−h_{FW}):
RVQ[=]RVU−RVI
SVQ[=]SVI−SVU
TCI[=]STU−SCI
TCQ[=]TH−FW

### Meaning of Terms

The words “Operating Parameters”, as taken within the general scope and spirit of the present invention, mean common data obtained from a nuclear power plant and its design parameters applicable for its thermodynamic understanding. Operating Parameters are used by both the Nuclear Model (using principally off-line data) and the calorimetric Model (using both analytical descriptions of the system and on-line data). “Off-Line Operating Parameters” typically comprise specifications and physical data, while “On-Line Operating Parameters” typically comprise measured thermodynamic states of the working fluids. Detailed descriptions of both On- and Off-Line Operating Parameters are provided in the “Calculational Engine and Its Data Processing” and “Clarity of Terms” sections.

“System Effect Parameters” (SEP) are selected Operating Parameters (on- or off-line) which directly impact the calorimetric Model, provided Reference SEPs are knowable with high accuracy or its value is established by experience as being highly consistent and reliable. The difference between the SEP and the value of its Reference SEP, is denoted as Δλₖ. For example, if the computed electric power is declared a SEP, its Reference SEP is the measured electric power (P_{UT}) resulting in P_{GEN-REF}. Both indirectly determined neutronic data, and directly measured quantities, may also be chosen SEPs . In addition to electric power, SEPs comprise the computed mass flows of the RV and TC, compared to the plant indicated.

The words “Choice Operating Parameters” (COP, Λₘ) as taken within the general scope and spirit of the present invention, are defined as meaning any sub-set of Operating Parameters (on- or off-line) which only indirectly impact the calorimetric Model. This disclosure assumes that COPs have errors, their absolute accuracies are (at least superficially) unknowable; said errors are correctable. COPs are selected by the user of the NCV Method from an available set. The computed power is verified following Verification Procedures , such that [Δλₖ→0.0] is achieved by varying a set of Λₘ.

### NSSS Thermal Powers and Efficiencies

It is an important assumption that the fission phenomenon is taken as an inertial process. Such a process is defined as self-contained, given an event release after incident neutron capture. The event release (fission) is only properly treated using the Second Law concept of exergy. Exergy's thermodynamic reference temperature is based on the neutron flux's lowest exergy commensurate with extracting the event release. Enthalpic processes, those that reference terrestrial standards [e.g., a ∫d(vP) work term], have no meaning for an inertial process. Essentially the entire event release is available for power production (its Δexergy). Only a small portion is irreversibly lost: RV convection loss treated by a Carnot engine, and antineutrino & minor neutron losses. Evidentiary support of the inertial treatment is the fact that total exergies from fission are observed to be dependent only on the number of emitted neutrons, not on incident “energies” nor atomic mass per se (see Sher and James references, cited below). Also, recall that the definition of an electron volt is a relative electronic charge (Δexergy) acquired given an induced 1.0 volt acceleration of that particle; these are incremental concepts. The same Mev/release would be observed in deep space and at the ocean's depths.

This invention first teaches to form a foundational description of the entire NSSS using a Second Law balance. This includes a balance about the Secondary Containment boundary comprising the Reactor Vessel (RV) for a PWR & BWR, and a Steam Generator (SG) and pressurizer for a PWR. Note, the total exergy flow supplied by fission is presented on the left-hand side of Eq. (1) plus exergy gains from pumps; its right-side contains useful output plus irreversible losses. Antineutrino (and possibly neutrino) losses are defined by Q_{LRV} per Eq. (3F). Convection losses from the RV to the environment stemming principally from gamma and beta radiation, Q_{RV-Loss}, is applicable for Carnot conversion; Q_{LRV} is not. Both are system irreversible losses which appear in Eq. (1). The exergy flow added by a Reactor Vessel pump k is given as (P_{RV-k}−m_{RV-k}Δg_{RV-k}) which combines the losses associated with delivering motive power to the fluid (termed “mechanical”, P_{RV-k}−m_{RV-k}Δh_{RV-k}), with traditional loss (“thermodynamic”, m_{RV-k}T_{Ref}Δs_{RV-k}) given imperfect pumping. For the RV, the aggregate pump flow is m_{RV}, where its pump Δexergy is weighted by individual flows resulting in Δg̅_{RVP}; thus the total loss ΣP_{RV-k}−m_{RV}Δg̅_{RVP}. In like manner, exergy flows added by TC pumps is given as: [ΣP_{TC-k}−m_{FW}Δg̅_{FWP}−Σm_{CD}Δg̅_{CDP}]. Condensate flows m_{CD} are resolved using methods best suited to the specific system, its flow measurements, etc. Typically Deaerator flows and condensate flows are assumed a fraction of final feedwater flow: m_{FW}C_{P-j}. Feedwater flow is replaced with the unknown m_{RV} via Eq. (4).

Φ_{TH} is neutron flux (¹n₀-cm⁻²-sec⁻¹), the driving function of the inertial process. In Eq. (1): Σ_{j=1,4} indicates summation of temporal fissile isotopes (j, comprising ²³⁵ U, ²³⁸U, ²³⁹Pu and ²⁴¹Pu); and Σ_{F-j} is the macroscopic fission cross section of isotope j consistent with the fuel's volume V_{Fuel}. The recoverable and unrecoverable exergy term, Φ_{TH}Σ_{j=1,4}[Σ_{F-j}(ν_{REC-j}+ν_{TNU-j})] is computed either as the quantity Φ_{TH}[Σ̅_{F}(t)ν̅_{TOL}(t)], refer to Eq. (26), or the individual terms are computed. Irreversible loss terms comprise: ν̅_{LRV}(t); pump and vessel Carnot losses; ∫[mdg]_{SG} is defined as [−m_{RV}Δg_{SVQ}+m_{FW}Δg_{TCI}] given Δg_{SVQ} is [inlet less outlet]; ∫[mdg]_{Tc} is minor, solved by iteration; and the Condenser's Q_{REJ}.

$${C}_{V} {Φ}_{TH} {\sum }_{j = 1 , 4} [ {\sum }_{F - j} ( {v}_{REC - j} + {v}_{TNU - j} ) ] + \sum {P}_{RV - k} + \sum {P}_{TC - k} = {P}_{GEN} - {P}_{GEN - Loss} + {C}_{V} {Φ}_{TH} [ {\overline{\sum }}_{F} ( t ) {\overline{v}}_{LRV} ( t ) ] + ( 1 - {T}_{Ref} / {T}_{CNI} ) {Q}_{REJ} - \int {[ mdg ]}_{SG} - \int {[ mdg ]}_{TC} + \sum {P}_{RV - k} - {m}_{RV} Δ {\overline{g}}_{RVP} + \sum {P}_{TC - k} - {m}_{FW} Δ {\overline{g}}_{FWP} + {P}_{FWP - Aux} - {m}_{FW} \sum {C}_{P - j} Δ {\overline{g}}_{CDP - j} + ( 1 - {T}_{Ref} / {T}_{RVI} ) {Q}_{RV - Loss} + ( 1 - {T}_{Ref} {T}_{FW} ) {Q}_{SG - Loss} \qquad ( 1 )$$

$${C}_{V} {Φ}_{TH} {\sum }_{j = 1 , 4} [ {\sum }_{F - j} ( {v}_{REC - j} + {v}_{TNU - j} ) ] - {P}_{GEN} - ( 1 - {T}_{Ref} / {T}_{CNI} ) {Q}_{REJ} + {m}_{RV} \{ - Δ {g}_{SVQ} + Δ {\overline{g}}_{RVP} + ( Δ {h}_{SVQ} / Δ {h}_{TCI} ) [ Δ {g}_{TCI} + Δ {\overline{g}}_{FWP} + \sum {C}_{P - j} Δ {\overline{g}}_{CDP - j} ] \} = {C}_{V} {Φ}_{TH} [ {\overline{\sum }}_{F} ( t ) {\overline{v}}_{LRV} ( t ) ] - {P}_{GEN - Loss} + {P}_{FWP - Aux} + ( 1 - {T}_{Ref} / {T}_{RVI} ) {Q}_{RV - Loss} + ( 1 - {T}_{Ref} / {T}_{FW} ) {Q}_{SG - Loss} + ( 1 - {T}_{Ref} / {T}_{TC} ) {Q}_{TC - Loss} - \int {[ mdg ]}_{TC} + \{ ( {Q}_{SG - Loss} / Δ {h}_{TCI} ) [ Δ {g}_{TCI} + Δ {\overline{g}}_{FWP} + \sum {C}_{P - j} Δ {\overline{g}}_{CDP - j} ] \} \qquad ( 2 ND )$$

In Eq. (2ND) and elsewhere, the following definitions apply:

G_{IN}≡C_{V} Φ_{TH} Σ_{j=1,4}[Σ_{F-j}(ν_{REC-j}+ν_{TNU-j})]+ΣP_{RV-k}+ΣP_{TC-k} (3A)

Q_{REC}≡C_{V} Φ_{TH} Σ_{j=1,4}[Σ_{F-j} ν_{REC-j}] (3B)

Q_{RVQ}≡C_{V} Φ_{TH} {Σ_{j=1,4}[Σ_{F-j} (ν_{REC-j}+ν_{TNU-j})]−[Σ̅_{F}(t)ν̅_{LRV}(t)]}−(1−T_{Ref}/T_{RVI})Q_{RV-Loss} (3C1)

Q′_{RVQ}=m_{RV}Δh_{RVQ} (3C2)

Q_{SVQ}=m_{RV}Δh_{SVQ} (3D)

Q_{LRV}≡C_{V}Φ_{TH}[Σ̅_{F}(t)ν̅_{LRV}(t)] (3F)

C_{E}≡5.4668556×10⁻¹; Btu sec MeV⁻¹ hr⁻¹

C_{V}≡C_{E} V_{Fuel}; Btu sec MeV⁻¹ hr⁻¹ cm³

C_{F}(t)≡C_{V}Σ̅_{F}(t); But sec MeV⁻¹ hr⁻¹ cm²

An important consideration for PWR analyses is a First Law balance about the Steam Generator (SG). For a BWR: Δh_{TCI}=Δh_{SVQ}; Q_{SG-Loss}=0.0; & m_{FW}=m_{RV}, before bleed-off Use of Eq. (4B) is made throughout when establishing m_{RV} an unknown (its reverse would apply to m_{FW} if it were declared an unknown).

m_{RV}Δh_{SVQ}=m_{FW}Δh_{TCI}+Q_{SG-Loss} (4A)

m_{FW}=(m_{RV}Δh_{SVQ}−Q_{SG-Loss})/Δh_{TCI} (4B)

To illustrate the practicality of having nexus between flux and RV coolant mass flow, consider the following. Assume typical data associated with a 1270 MWe PWR, given a vendor quoted flux of 1.0×10^{13 1}n cm⁻² sec⁻¹ and RV flow of 138.138×10⁶ lbm/hr. Compute the available power using Eq. (3B), and its consist neutron flux. Then, use Eq. (3C2) to compute Core Thermal Power, and then back-calculate flux. One quickly sees a factor of two error in flux using an enthalpic balance. If Core Thermal Power is to be accurately computed, NCV dedicates using a consistent understanding of the NSS System, using verification as appropriate, and only then, compute CTP directly based on the computed RV coolant mass flow.

$$\begin{matrix}{g}_{RVU} = 239.1944 Btu / lbm & {V}_{UO 2} = 8.88844 \times {10}^{6} {cm}^{3} \\ {g}_{RVI} = 191.4492 Btu / lbm & {\sum }_{F} = 0.656436 {cm}^{- 1} \\ {h}_{RVU} = 655.839 Btu / lbm & {v}_{REC} = 202.46 MeV / Fission \\ {h}_{RVI} = 566.0535 Btu / lbm & [ {C}_{E} {V}_{UO 2} {\sum }_{F} {v}_{REC} ] = 6.457951 \times {10}^{- 4}\end{matrix}$$

$$\begin{matrix}{Q}_{REC} & = & {Φ}_{TH} [ {C}_{E} {V}_{UO 2} {\sum }_{F} {v}_{REC} ] & Eq . ( 3 B ) \\ & = & {m}_{RV} [ {g}_{RVU} - {g}_{RVL} ] = & [ 1933 Mw - available ] \\ & & 0.659543 \times {10}^{10} Btu / lbm & \\ {Φ}_{TH} & = & {m}_{RV} [ {g}_{RVU} - {g}_{RVL} ] / & \\ & & [ {C}_{E} {V}_{UO 2} {\sum }_{F} {v}_{REC} ] = & \\ & & 1.021288 \times {{10}^{13}}^{1} n {cm}^{- 2} {sec}^{- 1} & \end{matrix}$$

$$Use Eq . ( 3 C 2 ) to compute Core Thermal Power , \\ then back - calculate flux :$$

$$\begin{matrix}{Q}_{RVQ}^{′} = {m}_{RV} [ {h}_{RVU} - {h}_{RVL} ] = & [ 3635 MW - thermal ] \\ 1.240279 \times {10}^{10} Btu / lbm & \end{matrix}$$

$${Φ}_{TH} {m}_{RV} [ {h}_{RVU} - {h}_{RVI} ] / [ {C}_{E} {V}_{UO 2} {\sum }_{F} {v}_{REC} ] \text{} 1.920546 \times {{10}^{13}}^{1} n {cm}^{- 2} {sec}^{- 1}$$

However, even though First Law application to core power is wrong prima facie, it does offer a missing equation if properly corrected. Although Eq. (2ND) is a foundation formulation, and can produce additional equations (to derive a PFP Model, to describe an isolated RV, etc.), to describe completely independent equations with up to four unknowns a unique equation is required as found in a corrected First Law balance of the NSSS. The bases of this disclosure is that the fission and fusion phenomena are inertial processes. Barring neutrinos & antineutrinos, their event releases are entirely available for power production, uniquely divorced from a referenced energy level. As stated above, event releases from inertial processes cannot be directly associated with enthalpic mechanics. Assigning a ∫d(vP) work to/from an inertial process has no meaning This said, difficulties encountered with using First Law concepts still must be addressed. To employ the First Law about the NSSS, used to add a missing equation, and to maintain consistency of a computed, absolute flux, conversion of the inertial fission exergy is required. If flux can be “assigned” a temperature via its kinetic energy using Boltzmann's teachings, it can also be associated with thermodynamic properties having temperature dependency. This dependency is found in the very definition of exergy, its reference temperature. The dead state for water is the triple point (32.018° F., i.e. for assigning: h_{f}=s_{f}=0.0), whereas exergy's conventional reference is the lowest temperature seen by the thermal system (its sink). Countering the conventional, the lowest temperature seen by a nuclear system is associated with its average, useful, subatomic particles—the particles' lowest exergy commensurate with extracting that exergy. This suggests a defined Ξ term, a function of T_{Ref}, be applied to all recoverable neutronic terms appearing in First Law relationships. Ξ(T_{Ref}) allows conversion of inertial exergy to a Δenergy; it is defined by Eq. (5) as the “Inertial Conversion Factor”. T_{Ref} is defined through iterative procedures given consistent thermodynamic properties of the fluid and exergy's definition: g=f(P,h,T_{Ref}). Typically, Ξ(T_{Ref}) is resolved by balancing the right- and left-sides of Eq. (1ST) by varying T_{Ref}, rapid convergence can be expected. Assumptions associated with Ξ(T_{Ref}) include that: 1) Ξ(T_{Ref}) is only defined for the inertial process per se, the reactor core; 2) Ξ(T_{Ref}) applies only to recoverable releases; and 3) T_{Ref}, once determined, must be applied consistently to all applicable NCV Method formulations; e.g., Eq. (2ND), Eq. (56B) and FCI computations.

Ξ(T_{Ref})≡(h_{RVU}−h_{RCI})/[g_{RVU}(T_{Ref})−g_{RCI}(T_{Ref})] (5)

A First Law expression for a complete NSSS comprises the following, incorporating Ξ(T_{Ref}) Eq. (6) is reduced by relating feedwater flow to RV flow at the Steam Generator via Eq. (4B).

$${C}_{V} {Φ}_{TH} {\sum }_{j = 1 , 4} [ {\sum }_{F - j} {v}_{REC - j} ] Ξ ( {T}_{Ref} ) + {m}_{RV} / Δ {\overline{h}}_{RVP} - {P}_{FWP - Aux} + \sum {m}_{CD - j} Δ {h}_{CDP - j} = {P}_{GEN} - {P}_{GEN - Loss} + {Q}_{REJ} + {Q}_{RV - Loss} + {Q}_{SG - Loss} + {Q}_{TC - Loss} \qquad ( 6 )$$

$${C}_{V} {Φ}_{TH} {\sum }_{j = 1 , 4} [ {\sum }_{F - j} {v}_{REC - j} ] Ξ ( {T}_{Ref} ) - {P}_{GEN} - {Q}_{REJ} + {m}_{RV} \{ Δ {\overline{h}}_{RVP} + ( Δ {h}_{SVQ} / Δ {h}_{TCI} ) ( Δ {\overline{h}}_{FWP} + \sum {C}_{P - j} Δ {h}_{CDP - j} ) \} = ( {Q}_{SG - Loss} / Δ {h}_{TCI} ) ( Δ {\overline{h}}_{FWP} + \sum {C}_{P - j} Δ {\overline{h}}_{CDP - j} ) + {P}_{FWP - Aux} - {P}_{GEN - Loss} + {Q}_{RV - Loss} + {Q}_{SG - Loss} + {Q}_{TC - Loss} \qquad ( 1 ST )$$

The iterative computations resolving Ξ(T_{Ref}), using Eq. (1ST) when describing a 1270 MWe PWR produced: Ξ(T_{Ref})=1.93593 at T_{Ref}=49.2477° F. This temperature produces an average exergy in the flux of 0.02436 eV, determined using Boltzmann's relationship: k_{B}T_{Ref}. This value certainly confirms the exergy of a common thermal neutron, and the understanding of an inertial fission process.

In summary, the above method maybe used for improving a performance monitoring of an operating NSS System, said System having a Reactor Vessel comprising a core containing fissile material in the presence of a neutron flux resulting in fission which heats a coolant flowing through the Reactor Vessel, the method comprising the steps of: a) obtaining thermodynamic states of the coolant at the core's entrance and exit, resulting in a set of enthalpy and exergy values; b) obtaining a First Law description of the operating NSS System comprising a correctable core energy flow, the First Law description being capable of determining a flow rate of the coolant flowing through the Reactor Vessel, resulting in a First Law Model of the NSS System; c) determining an Inertial Conversion Factor based on the set of enthalpy and exergy values and the First Law Model, resulting in an accurate First Law Model of the NSS System; and d) using the accurate First Law Model to determine the flow rate of the coolant flowing through the Reactor Vessel and thereby improving the performance monitoring of an operating NSS System by observing temporal trends in the flow rate of the coolant and/or in the absolute neutron flux.

A First Law balance is also made about an isolated Turbine Cycle forming a third equation. Except for m_{FW} & Q_{REJ}, all quantities in Eq. (7) are known with high accuracy; they are based on direct measurements and/or based on common treatment of TC equipment. As examples, common treatment assumes the Q_{TC-Loss} is principally composed of 0.2% loss from turbine casings; a 1% FW heater shell loss/heater; the driving temperature of vessel losses is the outer annulus temperature; etc., detailed below.

$$\begin{matrix}{m}_{FW} Δ {h}_{TCQ} = {P}_{GEN} - {P}_{GEN - Loss} + {Q}_{REJ} + {Q}_{TC - Loss} - & ( 7 ) \\ {m}_{FW} Δ {\overline{h}}_{FWP} + {P}_{FWP - Aux} - \sum {m}_{CD - j} Δ {\overline{h}}_{CDP - j} - & \\ {P}_{GEN} - {Q}_{REJ} + {m}_{RV} ( Δ {h}_{SVQ} / Δ {h}_{TCI} ) ( Δ {\overline{h}}_{FWP} + & \\ \sum {C}_{P - j} Δ {\overline{h}}_{CDP - j} ) & \\ = {P}_{GEN - Loss} + {Q}_{TC - Loss} + {P}_{FWP - Aux} + & ( 3 RD ) \\ ( {Q}_{SG - Loss} / Δ {h}_{TCI} ) ( Δ {h}_{TCQ} + Δ {\overline{h}}_{FWP} + & \\ \sum {C}_{P - j} Δ {\overline{h}}_{CDP - j} ) & \end{matrix}$$

The shaft energy flow delivered to the electrical generator, P_{GEN-REF}, a Reference SEP, is based on direct measurement at the generator terminals (P_{UT}), accounting for routine electrical and mechanical losses. Note that P_{UT} is considered to be measured with high accuracy (KWe gross output). Generator losses, f(P_{GEN}) in KWe, are determined using established art.

P_{GEN-REF}=3.412.1416(P_{UT}+L_{Mech}+L_{Elect}) (8)

In Eqs.(2ND), (1ST) & (3RD), the convective loss terms Q_{RV-Loss} & Q_{SG-Loss} are determined based on the thermal load of the air filtration & conditioning system of the Secondary Containment. Q_{REJ} is the Condenser's heat rejection to the tertiary system. The NSSS thermodynamic boundary is considered the outline of the working fluid in the condenser's shell, thus Q_{REJ} is lost to the environment. T_{RVI} & T_{FW} are surface temperatures of the RV & SG (if used), consistent with total Secondary Containment losses and noting that the entering colder fluid is routed to the outer annulus of the RV & SG vessels. For the typical PWR and BWR a fission neutron is absorbed, on average, as a thermal neutron (≈0.025 eV). The thermal region of flux is typically considered from 0.010 to 100 eV. Throughout these teachings it is understood that integrations comprising flux, macroscopic cross sections, etc. are a functions of incremental energy, expanded via Eqs. (21)-(26).

Evaluations of Q_{TC-Loss} and pump energy terms requires a detailed understanding of the Turbine Cycle as outlined in the following listing of terms; these quantities are considered summations and/or weighted averages of either environmental energies or equivalent net shaft powers.

Q_{TC-Loss}=+Heat exchanger losses to environment (e.g., FW heaters, MSR vessel, misc. casings)+Piping insulation losses+Letdown energy flow from the TC−Makeup energy flow to the TC−RV (and SG) changes in potential energy relative to the TC's throttle valve+Generator casing heat loss the environment−Generator coolant heat loss to the working fluid. (9)

It is important that T_{TC} of Eq. (2ND) in association with Q_{TC-Loss} be evaluated consistently. The Preferred Embodiment is to “mix” the energy flows of Eq. (9) to thus determine an equilibrium state and thus an average T_{TC} consistent with Q_{TC-Loss}. Eq. (10) comprise shaft powers or equivalence of shaft powers, all expressed by a generic [mₖΔh̅_{k-P}]_{TC}, incorporated into the Δh̅_{FWP} and/or ΣC_{P-j}Δh̅_{CDP-j} terms.

Σ[mₖΔh̅_{k-P}]_{TC}=+Total pump shaft energy flow delivered to the working fluid−Working fluid energy flow when used to power an auxiliary turbine-driven pump−Mechanical linkage loss associated with steam-driven pumps−Portion of working fluid energy flow used for a main turbine driven pump. (10)

In addition to these losses, there are, of course, a number of minor energy flows associated with ancillary systems associated with any power plant. For an NSSS such ancillary systems comprise: energy flows associated with Shim Control fluid injections; SG blow-down losses; control rod drive cooling; RV coolant pump miscellaneous seal flows; and the like. Given the definition of Core Thermal Power, correcting Eq. (3C2)'s Q′_{RVQ} for minor RV energy flows must be considered if seriously affecting h_{RVI}; in general such effects are a small fraction, <1×10⁻⁵, of Core Thermal Power.

Traditional treatment would assume the unrecoverable term, ν̅_{LRV}(t), used in Eqs. (2ND) cancels with ν̅_{TNU}(t) found in its total fission term; they carry the same meaning Such cancellation would appear simple mathematics; however, by option, the recoverable and unrecoverable exergies may be carried within the matrix solution as a single term, ν̅_{TOT}(t), and if so chosen there is no direct cancellation. Further, and of more importance, this is wrong given use of the NCV Model. Note that the solution to the NCV Method (or any such method) runs through a matrix solution which is dependent on its augmented matrix. An augmented matrix contains a defining column of constants associated with each independent equation. Constants used in NCV Method equations are all loss terms, by design, both conventional and neutrino & antineutrino. Thus, consider the following points. First, if taken as a constant, ν̅_{LRV} can be assigned any value—taken from TABLE 1, or another source, or zero—thus biasing a computed Φ_{TH}. Second, any set of declared unknowns, say Φ_{TH}, P_{GEN} & m_{RV}, upon resolution will be consistently apportioned by matrix solution dependent on thermodynamic losses. Their results will be biased if losses are biased. And third, loss terms appear in both First and Second Law treatments, both Laws must be conserved and be consistent regards application of losses. Eq. (2ND) leads directly to Eq. (1ST) via Eq. (5). The [Φ_{TH} ν̅_{LRV}(t)] product found in Eqs.(2ND) & (PFP), by user option, is carried either a constant or a COP. Therefore Eq. (2ND) and the PFP Model maybe modified with the following substitution:

C_{V}Φ_{TH}[Σ̅_{F}(t)ν̅_{LRV}(t)]=C_{F}(t)Ψ_{LRV}(t) (11)

where: Ψ_{LRV}(t)≡Φ_{TH}v̅_{LRV}(t) (12)

and if Ψ_{LRV}(t) is used as a COP, its assigned limitations include:

(1.0−C_{ϕν})Φ_{TH}(t)<[Ψ_{LRV}(t)/ν̅_{LRV}]<(1.030 C_{ϕν})Φ_{TH}(t) (13)

Note that if defined as a COP, Ψ_{LRV}(t) has intrinsic off-sets. For example an erroneously high flux will drive a back-calculated ν̅_{LRV}(t) lower and the reverse. Thus verification means that a resolved Ψ_{LRV}(t), either as a COP or an assumed constant produces the same average flux as the left side of Eq. (2ND).

Once the above equations and the PFP are solved, the following set of First Law thermal efficiencies are determined; they are a portion of the set of verified Thermal Performance Parameters. η_{SG} and η_{TC} are efficiencies for the SG and TC, their product produces NSSS efficiency. The use of Q′_{RV} is the total RV energy flow and thus η_{RV} is unity. As discussed, it is not possible to describe a First Law efficiency for an inertial process. For the Turbine Cycle, note that η_{TC} is based on [m_{FW}Δh_{TCQ}] which is determined using Eq. (7) given that m_{RV} [and thus m_{FW} via Eq. (4)] and Q_{REJ} are computed using NCV Methods, and thus allow miscellaneous First Law losses to be determined. Note that efficiencies may be converted to the commonly used heat rate term (Btu/kw-hr) via the ratio [3412.1416/Efficiency].

$$\begin{matrix}{η}_{SYS} = [ 3412.1416 {P}_{UT} / {Q}_{RV}^{′} ] & ( 14 A ) \\ = [ {m}_{RV} Δ {h}_{SVQ} / {Q}_{RV}^{′} ] [ {m}_{FW} Δ {h}_{TCQ} / ( {m}_{RV} Δ {h}_{SVQ} ) ] & ( 14 B ) \\ [ 3412.1416 {P}_{UT} / ( {m}_{FW} Δ {h}_{TCQ} ) ] & \\ = {η}_{RV} {η}_{SG} {η}_{TC} & ( 14 C )\end{matrix}$$

The cornerstone of the NCV Method is verification. Eqs.(2ND), (1ST) & (3RD) could well be solved for the unknowns Φ_{TH}, Q_{REJ} & m_{RV}. These equations, barring matrix Rank considerations, could provide three equations and three unknowns. Note, which is common art, when a matrix's Rank is equal to the number of equations the equations are said to be independent. However, consider that the nuclear power plant offers no parameter, but with two clear exceptions, having a priori high reliability and high accuracy which might serve verification. The thermodynamic state of a fluid, although typically highly accurate, offers nothing for verification without its concomitant mass flow. All commercial NSSS mass flows employ very large pipes; the reactor coolant, TC feedwater and the condenser's tertiary system use pipes with two foot diameters and above. Such flows are commonly measured with ultrasonic instruments, but these require normalization to an established and reliable reference. The two exceptions are certain neutronics and measured electric power. Although neutronics typically have high accuracy, they are dependent on a known burn-up and thus introduces uncertainty. Measured electrical power, P_{UT}, is the sole NSSS parameter which has high reliability and high accuracy at any time; P_{GEN-REF}, via Eq. (8) follows directly from P_{UT}. It is for this reason that P_{GEN}, as used in Eqs. (2ND), (1ST) & (3RD) is declared an unknown requiring an additional equation. Once solved by matrix, P_{GEN} is then driven to P_{GEN-REF} via Eq. (61) using multidimensional minimization analysis. Consistency between the shaft power input to the electric generator, P_{GEN}, and the directly measured generation at the terminals, P_{UT} (leading to P_{GEN-REF}), has obvious import. Per Eq. (8), if L_{Mech} and L_{Elect} are known with high accuracy, then the Reference SEP shaft power will well serve verification. However, questionable losses must be resolved such that the computed shaft power has the expected high reliability and high accuracy. Mechanical losses, L_{Mech}, are constant and well established in the industry. L_{Elect}, although typically linear with P_{GEN}, can be suspect given questionable vendor records, generator upgrades, and the like. However, after an operating history is established, the difference between an inferred [P_{GEN}/3412.1415] versus a directly measured P_{UT}, knowing L_{Mech}, will allow determination of L_{Elect} given P_{GEN} dependency.

In summary Eqs.(2ND) & (1ST) have declared unknowns Φ_{TH}, P_{GEN}, Q_{REJ} and m_{RV}, and Eq. (3RD) has unknowns P_{GEN}, Q_{REJ} and m_{RV}. Thus four unknowns given three fundamental equations. There are additional equations which might appear to the skilled, however to assure the matrix Rank is not compromised, again, a completely independent equation is required. This is established employing an average fuel pin, a Pseudo Fuel Pin (PFP), whose average axial neutron flux, Φ_{TH}, is the same flux satisfying Eqs. (2ND) & (1ST), but whose axial flux profile is not symmetric (skewed). It is this complete system which allows the determination of the set of verified Thermal Performance Parameters. Verification, in part, means establishing nexus between flux and useful output. Once nexus is established, a data base then intrinsically exists (e.g., neutron flux, RV coolant flow and Condenser heat rejection) from which the set of verified Thermal Performance Parameters is consistently determined. The set of verified Thermal Performance Parameters comprise traditional calorimetric data such as turbine and pump efficiencies, feedwater heater Terminal Temperature Differences and Drain Cooler Approach temperatures and similar treatments. However, the calorimetric Model's preferred data for monitoring NSSS components are Fission Consumption Indices (FCIs). The FCI concept is well established for fossil systems but its applicability for a nuclear systems requires novelty regards G_{IN} and irreversibility.

In summary a method is presented for improving a thermodynamic monitoring of a NSSS, the method comprising the steps of: I) before on-line operation: a) acquiring a Nuclear Model of the NSSS, b) acquiring a calorimetric Model of the NSSS, c) acquiring a set of Verification Procedures for the NSSS, d) using the Nuclear Model, the calorimetric Model, and the set of Verification Procedures to create a thermodynamic description of the NSSS, resulting in a NCV Method, and e) acquiring a computer programmed with the NCV Method; II) while operating on-line: a) using the computer programmed with the NCV Method to monitor the NSSS, producing on-line computations comprising a set of verified Thermal Performance Parameters, b) improving the thermodynamic monitoring of the NSSS by reviewing the set of verified Thermal Performance Parameters for temporal trends and making changes to NSSS operations based on those temporal trends.

### Neutronics Data

As will be seen, resolved calorimetrics and thus FCIs associated with a NSSS power plant are dependent on base neutronics and Nuclear Fuel Management (NFM) forming the Nuclear Model. Such data are important to the NCV Method as it provides temporal bases whose selected and computed parameters are more accurate than can be directly measured. It is this data which serves the calorimetric Model. Said data comprise: burn-up as a function of time; the rate of ²³⁵U & ²³⁸U depletion, and ²³⁹Pu & ²⁴¹Pu build-up; the indicated flux (used for trending); and physical dimensions of the core, fuel pins and fuel assemblies.

The most consistent recoverable exergy per fission values is presented in TABLE 1. Note that decay quantities are, of course, time dependent; listed are infinite decay times after irradiation. It is important to recognize, as taught in this disclosure, the details of assuming an inertial process. This said, the “true” inertial recoverable exergy is the summation of columns: F1+F3+F4+F9+F10+F11. These individual exergies are solely associated with the fission phenomenon following neutron capture. This recoverable total ignores incident neutron (F2) and non-fission capture (F6). Note it could be argued that delayed neutrons (F9), are also non-inertial. But the point to be made is that the true, prompt, recoverable inertial released is given by: F1−F2+F3+F4, as based on the total prompt observed by Sher and James. For the purposes of Eq. (2ND) and its derivatives, the actual recoverable exergy [F13, as used in Σ_{j=1,4}(Σ_{F-j} ν_{REC-j})] is taken as: F1+F2+F3+F4+F9+F10+F11. Thus the exergy of the system is enhanced by the incident neutron's kinetic energy. In summary, Column F5 is [F1+F2+F3+F4]. Column F7 is the total prompt recoverable including non-fission contributions, F5 plus F6. Column F12 is the total delayed recoverable, the sum of F9, F10 & F11. Column F13 is the total recoverable, F7 plus F12. Column F15 is the total release, F13 plus the neutrino F8 and antineutrino F14. Note that the literature employs the word “energy” as in “energies per fission”, etc. In the context of this disclosure, “exergy” is correct regarding the fission event; i.e., its “total exergy release” including associated losses (Q_{LRV}). However, the word “energy” is applicable for Carnot conversion of Q_{RV-Loss} regarding gamma & beta heating of the coolant. References, listed in order of importance, include: R. Sher, “Fission-Energy Release for 16 Fissioning Nuclides”, NP-1771 Research Project 1074-1, Stanford University, prepared for Electric Power Research Institute, Palo Alto, CA, March 1991; M. F. James, “Energy Released in Fission”, Journal of Nuclear Energy, vol. 23, pp. 517-36, 1969; R. C. Ball, et al., “Prompt Neutrino Results from Fermi Lab”, American Institute of Physics Conference Proceedings 98, 262 (1983), placed on the interne at https://doi.org/10.1063/1.2947548; S. Li, “Beta Decay Heat Following ²³⁵U, ²³⁸U and ²³⁹Pu Neutron Fission”, PhD Dissertation, U. of Massachusetts, 1997; and T. K. Lane, “Delayed Fission Gamma Characteristics of ²³⁵U, ²³⁸U and ²³⁹Pu”, Applied Nuclear Technologies, Sandia National Lab.

TABLE 1A
MeV/Fission, Prompt (0 < t < 2 sec)

| | Product | Incident | Prompt | Prompt | Prompt | Non-Fission | Recoverable | Neutrino |
|---|---|---|---|---|---|---|---|---|
| | K.E. | Neutron | Fission ¹n | Gamma | Total | Capture | ν_{PRC-j} | ν_{PNU-j} |
| Isotope | F1 | F2 | F3 | F4 | F5 | F6 | F7 | F8 |
| ²³⁵U | 169.12 | 0.03 | 4.79 | 6.88 | 180.82 | 8.80 | 189.62 | 0.68 |
| ²³⁸U | 169.57 | 3.10 | 5.51 | 6.26 | 184.44 | 11.10 | 195.54 | 0.86 |
| ²³⁹Pu | 175.78 | 0.03 | 5.90 | 7.87 | 189.58 | 11.50 | 201.08 | 0.56 |
| ²⁴¹Pu | 175.36 | 0.03 | 5.99 | 7.83 | 189.21 | 12.10 | 201.31 | 0.69 |

TABLE 1B
MeV/Fission, Delayed (2 sec < t < 10⁸ sec) & Totals

| | Delayed | Delayed | Delayed | Total | Recoverable | Antineutrino | Total |
|---|---|---|---|---|---|---|---|
| | ¹n₀, ν_{DNR-j} | Gamma, ν_{DGM-j} | Beta, ν_{DBT-j} | Delayed | ν_{REC-j}(t) | ν_{DNU-j}(t) | Exergy |
| Isotope | F9 | F10 | F11 | F12 | F13 | F14 | F15 |
| ²³⁵U | 0.01 | 6.33 | 6.50 | 12.84 | 202.46 | 8.07 | 211.21 |
| ²³⁸U | 0.02 | 8.02 | 8.25 | 16.29 | 211.83 | 10.22 | 222.91 |
| ²³⁹Pu | 0.00 | 5.17 | 5.31 | 10.48 | 211.56 | 6.58 | 218.70 |
| ²⁴¹Pu | 0.01 | 6.40 | 6.58 | 12.99 | 214.30 | 8.16 | 223.15 |

Φ̅(t)=∫_{S}^{E}Φ(t,e)de/(E−S) (21)

Σ̅_{F-j}(t)=Σⱼ^{S}∫_{S}^{E}Φ(t,e) Nⱼ(t)σ_{F-j}(e) de/Φ̅(t) (22)

Σ̅_{F}(t)=Σ_{F-35}(t)+Σ_{F-38}(t)+Σ_{F-39}(t)+Σ_{F-41}(t) (23)

ν̅_{REC}(t)=[Σ_{F-35}(t)ν_{REC-35}+Σ_{F-38}(t) ν_{REC-38}+Σ_{F-39}(t) ν_{REC-39}+Σ_{F-41}(t) ν_{REC-41}]/Σ̅_{F}(t) (24)

ν̅_{TNU}(t)={[Σ_{F-35}(t)[ν_{PNU-35}+ν_{DNU-35}(t)]+Σ_{F-38}(t) [ν_{PNU-38}+ν_{DNU-38}(t)]+Σ_{F-39}(t) [ν_{PNU-39}+ν_{DNU-39}(t)]+Σ_{F-41}(t) [ν_{PNU-41}+ν_{DNU-41}(t)]}/Σ̅_{F}(t) (25)

ν̅_{TOT}(t)≡ν̅_{REC}(t)+ν̅_{TNU}(t) (26)

The temporal sum of recoverable exergies, v_{REG-j}(t) within Eq. (24), is a function of ²³⁵U depletion, ²³⁸U capture or fast fission, and Pu buildup, producing reference values. ν̅_{REC}(t) plus ν̅_{TNJ}(t) is the total fission exergy produced including incident neutron and non-fission capture (as caused by the originating fission event), defined as ν̅_{TOT}(t). NFM data must share consistency with Eqs. (21)-(26). Nomenclature comprises the following fissile isotopes, j=1 to 4:35⇒²³⁵U; 38⇒²³⁸u; 39⇒²³⁹Pu; and 41⇒²⁴¹Pu. In addition to these common fission isotopes, there is, of course, ²³³U (given fertile ²³²Th). The integration limits of Eqs. (21) & (22) are chosen commensurate with the fissile isotope or as typically established by NFM: for thermal fission, S=0.01 eV, E=100 eV; for ²³⁸U, S=1.0 MeV, E=5 MeV. Number densities as a function of time, Nⱼ(t), are determined by NFM for each fissile isotope (j) over the NSSS burn-up cycle. These refinements are used in Nuclear Model.

TABLE 1 suggests both neutrino and antineutrino exergies are produced from fission, columns F8 & F14. The startup of a virgin core with a well insulated Reactor Vessel (say equivalent to ≈0.00 MeV/Fission)—thus with no delayed antineutrino production, and without shaft input, has no identifiable irreversible loss—and thus violates the Second Law. If the traditional prompt ν̅_{PNU}=0.0 then, at time zero, Eq. (3F) yields: ν̅_{TNU}(0)=ν̅_{LRV}(0)=0.0, and thus I_{core}=0.0. There is no non-passive process which operates without an irreversible loss. Given this, it is proposed that neutrino production occurs given prompt proton decay (producing a neutron, positron & neutrino) associated with the formation of fission fragments. The positron is annihilated with an atomic beta, producing a portion of the observed prompt gamma radiation. Note that no known experiment has measured a single fission event at a time scale required for proof. The literature generally supports this postulate. Work at CERN in 1977 (Ball) reported “These [experiments] showed that there was an unexpected source of neutrinos which apparently came from the decay of short lived particles”. Since the late 2010s, based on precise theoretical predictions, the measured antineutrino flux from a group of commercial reactors operating over years, seeing virgin fuel to high burn-ups, was reported (Fallot) as being low by 7.8%. This was identified with ²³⁵U fission products (but not ²³⁹Pu). These experimenters were examining the [¹n→¹H₁+β⁻+Antineutrino] reaction and not [¹H₁→¹n+β⁺+Neutrino], as it would have being masked by delayed antineutrinos. Such treatment means the traditional assumption of fission fragments (e.g., ¹⁴⁷La and ⁸⁷ Br) is in error by an atomic number. However, the traditional literature also supports the total exergies liberated from fission listed in column F15 (considering that F9 is dependent on a core's unique structural elements), and thus the totals of TABLE 1 are conserved. For the Preferred Embodiment of this invention, prompt neutrinos are assumed to be 7.8% of the traditional antineutrino exergy after infinite irradiation, ν′_{DNU-j}(∞), thus maintaining traditional totals. It could be argued that the traditional totals are in error, that prompt neutrino exergy is in proportion to observed prompt gamma radiation. Resolution can only be determined after applying this disclosure over a number of operational years noting that ν̅_{LRV} and Ψ_{LRV} COPs.

ν_{TNU-j}(t)=ν_{PNU-j}+ν_{DNU-j}(t) (27)

ν_{PNU-j}≡0.078 ν′_{DNU-j}(∞) (28A)

ν_{DNU-j}(t)=0.022 ν′_{DNU-j}(t) (28B)

As a practical matter, the NCV Method is concerned with monitoring a system at steady state. Typical data averaging is based on 15 minute running averages. However, given extension of the PFP Model, and its reactor dynamic capabilities, neutrino/antineutrino considerations become important; factional seconds become important. The delay times associated with TABLE 1 quantities are typically less than 2 minutes (the half-life of the first of six energy groups of the important delayed neutrons is 55 seconds, the second at 22 seconds, the third+<6 seconds). However, expansion of such time dependencies is well known art and amenable for PFP dynamic modeling. References include: R. C. Ball, et al., “Prompt Neutrino Results From Fermi Lab”, American Institute of Physics Conference Proceedings 98, 262 (1983); placed online at https://doi.org/10.1063/1.2947548; and M. Fallot, “Getting to the Bottom of an Antineutrino Anomaly”, Physics, 10, 66, Jun. 19, 2017, published by American Physical Society.

### Fission Consumption Indices

This invention teaches, after solving consistent calorimetrics for the Reactor Vessel, the PWR Steam Generator, and components in the Turbine Cycle, to then perform analyses for “locating a set of thermal degradations” in the NSSS. Locating the set of thermal degradations is meant to provide information to the operator as to where in the system degradations are occurring. Fission Consumption Indices identify component degradations and the power process. When a non-power FCI (an irreversible loss) increases, the neutron flux and thus the fission rate must increase to maintain generation, or generation will decrease; thermal efficiency and effectiveness will decrease in either case. For example, the operator might observe higher irreversible losses commensurate with reduced electrical output with knowledge of where in the system the higher losses are located. Or the operator might observe higher irreversible losses in one or more components with off-setting decreases in others, but perhaps with constant FCI_{power}. Specifically, the NSSS operator—for the first time—has a nexus between neutronics, component losses and electrical generation . . . provided G_{IN} and ΣIₖ are uniquely defined.

G_{IN} is the total exergy potential from fission plus motive shaft power inputs; from which only thermodynamic irreversibilities and power output results. Eq. (31A) presents fission's total exergy potential, Q_{FIS} as is defined by the first term of Eq. (3A). Note that shaft input quantities (pumps) are carried with G_{IN} as an accounting convenience given the large powers associated with RV's pumps, thus affecting ϵ_{RV}. With this accounting exception, an important quality of G_{IN} as used for inertial processes is that it only represents an exergy which is “available” for useful output. Adding heat to an inertial process will only increase irreversible losses.

$$\begin{matrix}{G}_{IN} = {Q}_{FIS} + \sum {P}_{RV - k} + \sum {P}_{TC - k} & ( 31 A ) \\ = {P}_{GEN} + \sum {I}_{k} & ( 31 B )\end{matrix}$$

$${G}_{IN} of Eq . ( 31 A ) and \sum {I}_{k} of Eq . ( 33 ) are then used to \\ define F C I ' s for the nuclear system :$$

$$1000 = {FCI}_{Power} + \sum {FCI}_{Loss - k} \qquad ( 32 )$$

G_{IN} comprises, principally, the obvious recoverable and the unrecoverable exergies (antineutrino and possibly neutrino) liberated from fission, per TABLE 1. Flowing from G_{IN}, FCIs are fundamentally a unitless measure of the fission rate, its exergy flow, assigned thermodynamically to those individual components or processes responsible for the consumption of fissile material. It quantifies the exergy and power consumption of all components and processes relative to the total fission rate; by far the predominate term is the fission's recoverable energy, Q_{REC} of Eq. (3B). For example, if the Turbine Cycle's Moisture Separator Reheater (MSR) component's FCI, increases from 200 to 210 (i.e., higher irreversible losses), which is just offset by an decrease of 10 points in FCI_{power}, with no other changes, the operator has absolute assurance that a 5% higher portion of the fission exergy is being consumed to overcome higher MSR losses, at the expense of useful power production . . . thus recent changes to the MSR have had an adverse affect on the system.

For the nuclear system, the irreversibility term used to define FCI_{Loss-k} in Eq. (32), is given by Eq. (33). Fission induced irreversibilities are divided in two parts. One portion is the conventional heat flow at the RV boundary and a loss to the environment via Carnot conversion. It is transmitted through either the exchange of kinetic molecular activity and/or electromagnetic wave propagation; this comprises fission's gamma and beta radiation absorbed by the coolant. This loss is “a conventional thermodynamic loss”, in Eq. (33), the Σ(1.0−T_{Ref}/Tₖ)Q_{k-Loss} term. The second portion of nuclear losses are those exergies, originating from the inertial process, which cannot produce a Carnot conversion, this includes the antineutrino (and possible neutrino). As explained, such exergies are fundamentally described by dimensionless Δentropy: ΔS′=∫∂Q/(k_{B}T). In summary, these losses are expressed as an encompassing Q_{NEU-Loss} term. Antineutrinos and neutrinos are clearly ideal losses as their exergies are lost to our solar system. Irreversibility for the nuclear system is therefore defined by the following which includes a generic unrecoverable term (antineutrino, neutrino and possible neutron leakage, Q_{NEU-Loss}.

ΣIₖ=Σ(1.0−T_{Ref}/Tₖ)Q_{k-Loss}+Q_{NEU-Loss}+Σ(Pᵢᵢ−mᵢᵢΔgᵢᵢ)ₖ−∫[mdg]ₖ (33)

where: ∫[mdg]ₖ=0.0 for the fission process (discussed below), thus for the Reactor Vessel:

I_{RV}=(1.0−T_{Ref}/T_{RVI})Q_{RV-Loss}+Q_{NEU-Loss}+ΣP_{RV-k}−m_{RV}Δg̅_{RVP} (34)

and if ν̅_{LRV} is used as a COP, its assigned limitations include:

ν̅_{PNU}≤ν̅_{LRV}(t)≤C_{dν}ν̅_{TNU}(t) (35)

The upper limit of Eq. (35) is reasonably defined by the user consistent with the inertial process; a best mode practice suggests: C_{dv}=2.0. Direct benefit of this approach comprises:
1) Eqs. (34) & (35) allows additional terms incorporated into Eqs. (2ND) & (PFP), as

COPs, based on the declared unknowns such that the matrix solution is not sparse, while an accurate absolute flux is computed.
2) It is consistent with the use of [ν̅_{REC}(t)+ν̅_{TNU}(t)] regards G_{IN} of Eqs. (2ND), (3A), etc.
3) The values of ν̅_{LRV}(t) and/or Ψ_{LRV} if taken as COPs, as limited by Eqs. (13) & (35), assist verification of P_{GEN} and other system parameters.
4) If the understanding of neutrino & antineutrino is correct, and if ν̅_{LRV}(t)≥ν̅_{TNU}(t) is observed, then the affects of additional (unrecognized) neutrino or antineutrino production will become apparent; e.g., ²³⁸U capture and subsequent beta decay.

The Second Law demands for all non-passive processes that: ΣIₖ>0.0. The first and second terms on the right-side of Eq. (33) represent the maximum exergy flow to the environment given Carnot conversion, and a loss of the unrecoverable exergy associated with an inertial process. The third term represents losses due shaft inputs. Traditionally, the ∫[mdg]ₖ term represents any non-passive process having exergy exchange. For example, viable feedwater heaters in a TC, or the SG, must produce a negative exergy balance, ∫[mdg]ₖ, thus an increase in irreversibility per Eq. (33); i.e., a viable heat transfer from shell to tube for a FW heater (for a SG, viable heat transfer from tube to shell). As defined herein, this term carries both the traditional definition applicable to physical components, but also any non-shaft exergy addition to the nuclear system. However, relative to a fission core volume per se, ∫[mdg]ₖ has no obvious application.

However, in support of the nuclear importance and teachings of Eq. (33), consider ∫[mdg]ₖ and Q_{NEU-Loss} in combination as applied to the fusion process employing a magnetic confinement of its plasma, such as the popular Tokamak magnetic confinement. If using magnetic confinement, descriptions of the fusion process must include an “exergy equivalence of the magnetic confinement”, termed ∫dG_{MC}, which has the same meaning as ∫[mdg]ₖ. The numerical value of the exergy equivalence of the magnetic confinement is taken as the gross electrical power delivered to the magnetic system less conventional thermodynamic losses comprising electrical resistance and magnetic field leakage. Inductance if adding exergy to the inertial process, is not such a loss. However, for a magnetic confinement the exergy equivalence is always positive thus reducing ΣIₖ. This may well thwart the Second Law and thus the viability of a given fusion design. For example, the exergy yield from a D-T reaction is 17.6 MeV/Fusion, its neutrino exergy is approximately 5 MeV/Fusion. A proportionally large Q_{NEU-Loss} implies a large influence on a computed plasma flux, and will, of course, always increase ΣIₖ. However, an even larger influence, which will decrease ΣIₖ, may well stem from a positive f dG MC contribution from magnetic confinement. When assuming statistical thermodynamics for the pure & isolated process, pump losses are not considered, thus for the fusion process per se, a large ∫dG_{MC} will drive ΣIₖ→0.0, reducing Eq. (33) to:

∫dG_{MC}<Σ(1.0−T_{Ref}/Tₖ)Q_{k-Loss}+Q_{NEU-Loss} (36)

Eq. (36) states that for fusion viability, that is conserving the Second Law, exergy (or its equivalent) supplied from magnetic confinement must be less than the sum of the Carnot conversion loss found at the boundary (based on Q_{k-Loss}) and neutrino losses (Q_{NEU-Loss}). This principle applies to any inertial process, fission or fusion. Eq. (36) may be achieved by increasing Q_{k-Loss}, but at the obvious expense of system viability. A goal of ∫dG_{MC}<Q_{NEU-Loss} would appear both desirable and practicable for the design of fusion systems if producing useful output greater than burning paperwork. If this is not achieved through use of low magnetic power, using superconductors, then the fusion system will not function given a computed ΣIₖ<0.0. In support of Eq. (36), note that: a sun's fusion process is only viable in the presence of cold gravity; a fusion bomb is initiated via extreme pressure (not temperature); and the collision of two suns must result in extinction of their fusion fires which is another form of adding an exergy equivalence to the inertial process. Further, the forcing function of any nuclear inertial process is flux (either neutron or plasma); a computed value. For any nuclear system to be understood, requiring a flux solution, and thus correctly monitored, the Q_{NEU-Loss} term has huge import if the process' forcing function is to be computed. For fusion, ignoring Q_{NEU-Loss} and/or ∫dG_{MC}, is to misunderstand the inertial process. The neutrino is God's imprimatur on the Second Law.

In summary, a method is developed for qualifying a nuclear fusion process comprising a magnetic confinement of its plasma, the process having a conventional thermodynamic loss and a neutrino loss, the method comprising the steps of: a) formulating a set of Second Law terms comprising an exergy equivalence of the magnetic confinement resulting in an exergy gain, and a summation of the conventional thermodynamic loss and the neutrino loss resulting a summation of losses; b) using the exergy gain and the summation of losses to create a test in which the exergy gain is less than the summation of losses, resulting in a positive test of its Second Law viability; c) qualifying the nuclear fusion process by applying the positive test of its Second Law viability.

Second Law “efficiencies”, termed effectivenesses follows below; they are a portion of the set of verified Thermal Performance Parameters. ϵ_{RV}, ϵ_{SG} and ϵ_{TC} are effectivenesses for the RV, SG and TC, their product produces system effectiveness for the NSSS.

$$\begin{matrix}{ε}_{SYS} = [ 3412.1416 {P}_{UT} / {Q}_{IN} ] & ( 37 A ) \\ = [ {m}_{RV} Δ {g}_{SVQ} / {G}_{IN} ] [ {m}_{FW} Δ {g}_{TCQ} / ( {m}_{RV} Δ {g}_{SVQ} ) ] & ( 37 B ) \\ [ 3412.1416 {P}_{UT} / ( {m}_{FW} Δ {g}_{TCQ} ) ] & \\ = {ε}_{RV} {ε}_{SG} {ε}_{TC} & ( 37 C )\end{matrix}$$

### Pseudo Fuel Pin Model

To complete the solution matrix, an additional equation is required which is afforded with the PFP Model. This Model couples neutron flux and the buckling parameter with an axial exergy flow. This Model couples neutron flux and the buckling parameter with an axial exergy flow. The PFP is a single fuel pin having the same fuel pellet radius (r₀), clad OD, cell pitch, height of the active core (2Z), enrichment and burn-up, as the core's average. Although the PFP Model is theoretical, its computed average neutron flux, Φ_{TH}, is the real, actual flux satisfying Eqs. (2ND) & (1ST) and thus the solution matrix. The pin's axial neutronic buckling is the core's theoretical buckling at criticality. The PFP Model assumes:
the PFP is “positioned” at the core's radius associated with its mean area, at r_{FC}/√2;
the core's radial flux profile is flat at r_{FC}/√2, thus: J₀ (2.4048 r/R′)=1.0;
the PFP's radial flux profile within the fuel pin is constant, ∂Φ(r)/∂r=0.0;
the PFP's axial flux profile used for solution matrix is a Clausen Function of Order Two, a skewed trigonometric function;
steady state is assumed, given Calculational Iteration time>fluid transport time.
the average flux Φ_{TH} used in Eqs. (2ND) & (1ST) defines the PFP's average flux as developed for the Clausen Function; and
the PFP Carnot RV loss is: (1−T_{Ref}/T_{RVI})Q_{RV-Loss}/M_{FPin}, as only affecting fluid
   in the vessel's outer annulus, a loss of (g_{RVI}−g_{RCI}) before core entrance. It is obvious that enhanced sophistication could be applied to any of these assumptions. However, such enhanced sophistication cannot affect the base concept: employing a skewed flux profile with partial axial solution of the exergy rise, thus adding a viable fourth equation. This is clearly preferred over conventional convection heat transfer correlations. Such correlations are: empirical; based on temperature profiles (not Aenergy per se); fit experimental data without neutronics; and are void of Second Law concepts.

Neutron diffusion theory traditionally assumes a symmetric cosine for its axial solution. For the PFP Model, the Clausen Function is assigned this role in conjunction with pseudo-buckling, B_{P}².

0.0=∇² Φ(r,z)+B_{P}² Φ(r,z) (41)

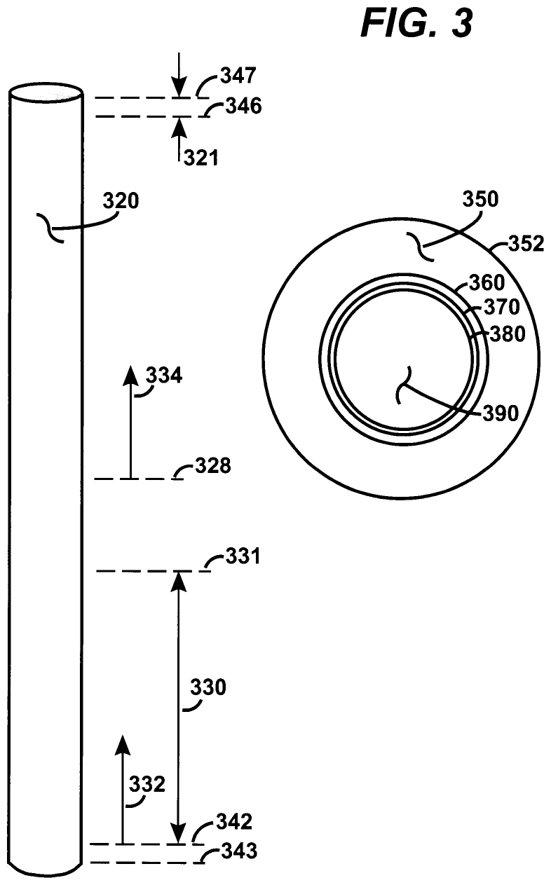

Eq. (41) when classically solved for a finite cylinder, a [Φ_{MAX}J₀(2.4048r/ R′)cos (πz/2Z ′)] relationship results. Theoretical boundaries at the core's radius R′ and axial at ±Z′ are assumed locations for zero flux. Refer to FIGS. 3 & 5. Well-known to one skilled, the underlying theoretical base of Eq. (41) leads to a definition of buckling given a large reactor which is slightly supercritical, (k_{EFF}−1.0)/(B_{P}² M_{T}²), where M_{T} is the neutron migration length or its equivalence. The Bessel J₀ function (or the Modified Bessel I₀ for the solid pin) is unity given the pin's assigned placement and PFP assumptions. B_{P}² is defined traditionally:

B_{P}²≡[π/(2Z′]² (42A)

where: Z′≡Z+M_{T} (42B)

and if B_{P} is used as a COP, its assigned limitations include:

2Z<πB_{P}<2(Z+M_{T}+C_{M}) (43)

Eq. (43) is a check on the reasonableness of a computed B_{P} when chosen as a COP; this serves as a most sensitive verification vehicle. C_{M} is a +ΔM_{T} uncertainty on migration length as determined by judgement, experimental data and/or a computed COP. For the typical light water reactor a reasonable value of C_{M} is 1.5 cm.

The hydraulic annulus for flow surrounding the PFP is the core's total area less fuel pin and structural areas, divided by the number of pin cells available for coolant flow, M_{TPin}. The number of pins producing power is M_{FPin}. A given an axial Δz (or Δy) slice of the pin will see a Δexergy increase associated with a scaled, axial potential based on the recoverable: [Φ_{TH} Σ̅_{F}(t) ν̅_{REC}(t)]. In summary, the fuel pins' Δz slice from (n−1) to (n) will produce an exergy gain in the fluid per slice per pin of q_{n-2nd}; its T_{Ref} via Eq. (5). Of course, q_{n-Flux}=q_{n-2nd} at any Δz position within the core.

q_{n-Flux}≡C_{E}πr₀²·{Σ_{j=1,4}[Σ_{F-j}ν_{REC-j}]}·Φ_{MAX-CO}[cos(B_{P}zₙ)]Δz (44A)

q_{n-2nd}≡(m_{RV}/M_{FPin})(gₙ₋₁) (44B)

Q_{RVC}=Σ_{n=1,N}[q_{n-Flux}]=Σ_{n≤1,N}[q_{n-2nd}]=m_{RV}(g_{RVU}−g_{RCI}) (45)

Q_{RVC} represents the totals of Eq. (44) where g Ro is taken at the core's entrance after vessel Q_{RV-Loss}.

Integration of Eq. (44) is taken the core's entrance (RCI), not to its outlet (RVU) but to some distance less, taken from its centerline (±z) or entrance (y).

$${\int }_{- Z}^{z} {C}_{E} π {r}_{0}^{2} \cdot \{ {\sum }_{j = 1 , 4} [ {\sum }_{F - j} ( {v}_{R E C - j} + {v}_{T N U - j} ) ] \} \cdot {Φ}_{MAX - C O} [ cos ( {B}_{P} z ) dz {\int }_{0}^{y} ( {m}_{RV} / {M}_{FPin} ) [ {g}_{Core} ( y ) - {g}_{RCI} ] dy + {\int }_{- Z}^{z} {C}_{E} π {r}_{0}^{2} \cdot \{ {\sum }_{j = 1 , 4} [ {\sum }_{F - j} {v}_{TNU - j} ] \} {Φ}_{MAX - CO} [ cos ( {B}_{P} z ) dz \qquad ( 46 )$$

Since solution to Eq. (41) describes the shape of the flux, which is independent of power, for all symmetric trigonometry functions the φ_{MAX-CO} value will always be found near the centerline, at z=0.0 (y=Z). Any symmetric trigonometry function about (z) will always produce an essentially uniform exergy gain about the core's centerline. Thus an Eq. (2ND)-like formulation is simply repeated. For non-boiling reactors, changes in specific volume, viscosity, fluid velocity, etc. are simply not sufficient to effect significant asymmetry. In developing a fourth equation, although the partial integration of a symmetric Eq. (46) is useful for parametric studies, to maximize computational independence, integration of an asymmetric function is the Preferred Embodiment. Such a function, f (Ψ), should satisfy: i) f(Ψ)=0.0 at ψ=bπ, b=0, 1, 2, . . . ; ii) integrates to unity from zero to it; iii) is periodic and odd over any 2bπ; iv) f(ψ) is skewed; and v) ideally, has a non-unity peak. This is the Clausen Function of Order Two, Cl₂ (Ψ).

Cl₂(ψ) is defined by an infinite summation, reduced using a polynomial fit with coefficients Eₘ, where Ψ is a function of both axial position and B_{P}, all shifted by M_{T}.

$${Cl}_{2} ( Ψ ) ≡ {\sum }_{k = 1}^{∞} sin [ k Ψ ( y ) ] / {k}^{2} = {\sum }_{m = 1}^{7} {{E}_{m} [ Ψ ( y ) ]}^{m - 1} \qquad ( 47 )$$

$$where : Ψ [ y ] ≡ ( y + {M}_{T} ) {B}_{P} .$$

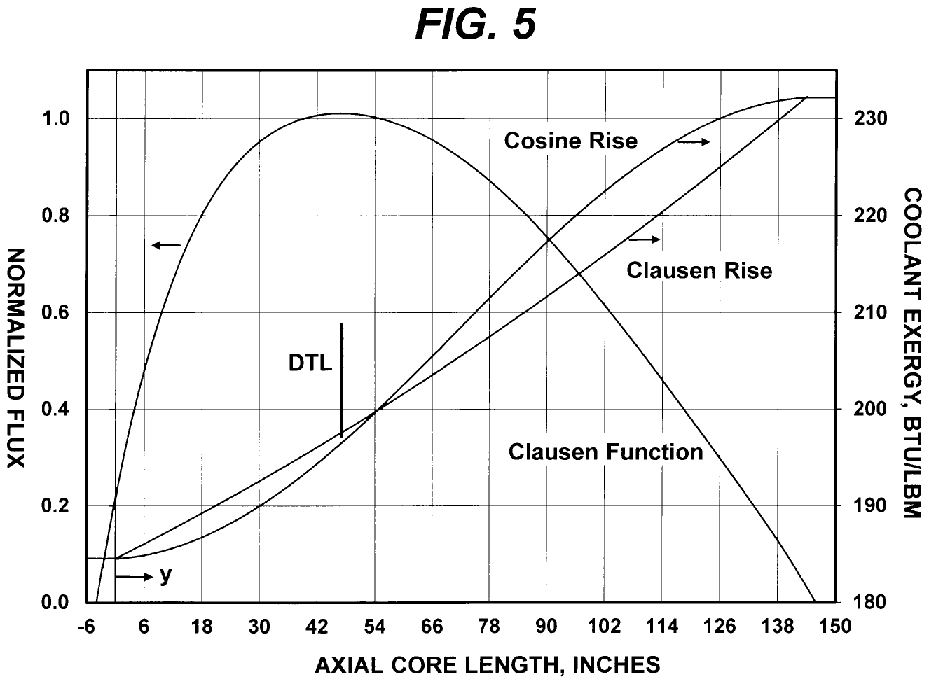

Thomas Clausen developed his function in 1832, it is well known to mathematicians. There are a number of schemes for computing Cl₂(Ψ) (e.g., using Chebyshev coefficients and others). Its direct integration is apparently allusive. The fitting polynomial, normalized to exactly unity area, satisfies all functionalities. For use with the NCV Method, Ψ(y) is off-set accounting for the buckling phenomena assuming zero flux at the profile's boundaries: Ψ[y₀=−M_{T}]=0.0, and at: Ψ[y₃=2Z+M_{T}]=2(Z+M_{T})B_{P}=π. Refer to FIG. 5. Note that the Clausen's peak is non-unity, defined by Cl₂(π/3).

The Clausen when applied to the PFP results in the following, following Eq. (46). In Eq. (48) the limits include: y₁=0, and (y) which is chosen for asymmetry.

$${\int }_{y 1}^{y} {C}_{E} π {r}_{0}^{2} \cdot \{ {\sum }_{j = 1 , 4} [ {\sum }_{F - j} ( {v}_{R E C - j} + {v}_{T N U - j} ) ] \} \cdot {Φ}_{MAX - C L} {\sum }_{m = 1}^{7} {{E}_{m} [ Ψ ( y ) ]}^{m - 1} d Ψ = {\int }_{y 1}^{y} ( {m}_{RV} / {M}_{FPin} ) [ {g}_{Core} ( y ) - {g}_{RCI} ] dy + {\int }_{y 1}^{y} {C}_{E} π {r}_{0}^{2} \cdot \{ {\sum }_{j = 1 , 4} [ {\sum }_{F - j} {v}_{TNU - j} ] \} {Φ}_{MAX - CL} {\sum }_{m = 1}^{7} {{E}_{m} [ Ψ ( y ) ]}^{m - 1} d Ψ \qquad ( 48 )$$

The peak flux, Φ_{MAX-CO} and Φ_{MAX-CL}, as with any such function must be substituted for the average flux a declared Eq. (2ND) & (1ST) unknown. The average flux, Φ_{TH}, is determined by obtaining the average integration over the entire length of the PFP.

$$\begin{matrix}{Φ}_{TH} = \{ {Φ}_{MAX - CO} / [ + Z - ( - Z ) ] \} {\int }_{- Z}^{+ Z} cos ( z {B}_{P} ) dz = & ( 49 ) \\ {Φ}_{MAX - CO} [ ( 2 / π ) ( 1. + {M}_{T} / Z ) ] {sin [ ( 2 / π ) ( 1 + {M}_{T} / Z ) ]}^{- 1} & \\ = \{ {Φ}_{MAX - CL} / [ 2 Z - 0. ] \} ( 2 / {B}_{P} ) {\sum }_{m = 1}^{7} {{E}_{m} [ Ψ ( y ) ]}^{m} / m {\vert}_{y1}^{y2} & ( 50 A ) \\ = {Φ}_{MAX - CL} [ ( 2 / π ) ( 1 + {M}_{T} / Z ) ] {\sum }_{m = 1}^{7} {{E}_{m} [ Ψ ( y ) ]}^{m} / m {\vert}_{y 1}^{y 2} & ( 50 B )\end{matrix}$$

Eq. (50A)'s (2/B_{P}) factor reflects the integration of a ∫sin [Ψ(y)] function, and the unique method of evaluating Ψ(y) that is when employing the classic B_{P} via Eq. (42A).

When converting the cosine axial peak Φ_{MAX-CO} to the average, the literature repetitiously assumes: Φ_{MAX-CO}=(π/2) Φ_{TH}. This is not correct. As taught here is to evaluate the average flux associated only with the active core; i.e., its production of thermal power. Thus, Φ_{TH} must be evaluated as the average of the integration about the z-axis given the chopped cosine from −Z to +Z (not ±Z′). For the common PWR, Eq. (49) becomes significant. Given a 12 foot active core with M_{T} taken as 6.6 cm, Eq. (49) yields C_{MAX}≈1.518 (vs. the traditional π/2); see TABLE 2. Thus if ignoring Eq. (49), the computed flux would be high by 3.5%. For the methods taught, this error would catastrophically bias computed electrical power, reactor coolant flow, etc. It explains, in part, why the industry believes errors in NSSS understanding range from 3 to 5%. Clausen's C_{MAX-CL}, is computed in the same manner as C_{MAX-CO}. Results of the average integration, Eq. (50), were taken from y=0 to 2Z. Note that Eqs. (49) & (50B) produce a “PFP Kernel” herein defined as: [(2/π)(1+M_{T}/Z)]. This term appears in all trigonometrically-based profiles, comprising a translation from Φ_{MAX} to Φ_{TH}.

In summary the method exampled by Eqs. (49) & (50B) applies to any system using a neutron or plasma flux, provided its profile assumes a theoretical leakage at its physical boundaries (described by M_{T}) and is derived from an integratable function. TABLE 2 presents relationships between Φ_{MAX} and Φ_{TH}; they are based on the PFP Kernel where M_{T}=6.6 cm, and 2Z=144 inches.

TABLE 2
Summary of C_{MAX}

| Flux Profile | C_{MAX} = Φ_{MAX}/Φ_{TH} |
|---|---|
| Cosine, no leakage (M_{T} = 0.0) | π/2 = 1.57079633 |
| Cosine with leakage | Eq.(49) => 1.51835422 |
| Clausen, no leakage (M_{T} = 0.0) | Eq.(50B) => 1.76589749 |
| Clausen with leakage | Eq.(50B) => 1.70603654 |

As applied to the NCV Method's PFP integration of Eq. (48) is made from the core's entrance to the point that asymmetry is most pronounced, designated as y̅. y̅ is herein defined as the “Differential Transfer Length” or DTL; i.e., the distance when “transitioning” from symmetry to asymmetry. For the PWR the DTL is typically chosen at the Clausen's peak. For the BWR without re-circulation, asymmetry is considerably simpler, typically defined at the point DNB is reached. However, if the BWR employs re-circulation flow, then PWR methods would apply. The location of the DTL is chosen to maximize asymmetry between the exergy profile versus one conventionally produced. The DTL is dependent on the reactor type and operational characteristics, but once chosen should be held constant for integration and subsequent monitoring. Finally, the governing equation stemming from Eq. (48) when integrated to the DTL point and substituting for C_{MAX-CL}, results in an unique equation (i.e., with distinct coefficients) versus Eqs. (2ND) or (1ST) . . . the matrix Rank is not diminished.

$$( 2 {D}_{1} / {B}_{P} ) [ {\overline{v}}_{REC} ( t ) + {\overline{v}}_{LRV} ( t ) ] {Φ}_{TH} + {D}_{4} {m}_{RV} = ( 2 {D}_{1} / {B}_{P} ) {Ψ}_{LRV} \qquad ( PFP )$$

$$where :$$

$${D}_{1} = {C}_{E} π {r}_{0}^{2} {\overline{\sum }}_{F} ( t ) {C}_{M A X - CL} {\sum }_{m = 1}^{7} {{E}_{m} [ Ψ ( y ) ]}^{m} / m {\vert}_{y 1}^{\overline{y}} \qquad ( 56 A )$$

$${D}_{4} = - [ {g}_{Core} ( \overline{y} ) - {g}_{R C I} ] / {M}_{{FP}_{in}} \qquad ( 56 B )$$

For BWR analysis, it has been found that a Clausen Function, if taken in mirror image, matches the flux profile remarkably well given changes in void fraction in the upper half of the core. The same techniques developed are applied, provided a “π-Shifted Clausen” is employed. The it-Shifted Clausen means its profile, and integrations, are shifted as follows given the Function is periodic and odd:

TABLE 3
Clausen Core Integration Boundaries

| Standard | π-Shifted |
|---|---|
| Ψ[y₁ = 0] = (y₁ + M_{T})B_{P} | Ψ[y₁ = 0] = \| (y₁ − 2Z − M_{T}) \| B_{P} |
| Ψ[y₂ = y̅] = (y̅ + M_{T})B_{P} | Ψ[y₂ = y̅] = \| (y̅ − 2Z − M_{T}) \| B_{P} |

After matrix resolution, the resolved Φ_{TH} and m_{RV} may then be used in a conventional analytics for separate study. In separate study, post-matrix, the DTL may be changed to the centerline for the PWR, y̅=Z. Thus, post-matrix, the PFP Model allows the following findings as a function of time: the axial position in the core where hₙ≈h_{f} (i.e., liquid saturation is being approached); and the axial position in the core where hₙ≈h_{g} (i.e., an approach to DNB for the BWR).

The development of the DTL suggests temporal parameters such as ∂y̅/∂t, ∂y̅/∂y, and ∂(Δg_{Core}/2)/∂t which have importance for reactor control and safety. These quantities are termed “PFP Reactor Safety Parameters”. The change in reactivity, based on full axial integration using Eqs. (46), (48) or similar, is important to dynamic study. A temperature coefficient, α_{T}, is routinely determined from commissioning tests and/or from PFP Reactor Safety Parameters. The multiplication coefficient, k, is provided from fission chamber data and/or online NFM. A reactivity feedback coefficient, dρ/dt, then follows where ρ=(k−1.0)/k.

α_{T}=(1/k_{EFF})² dT/dt (57)

dρ/dt≈−α_{T}ΔT/Δt (58)

dρ/dt and the PFP Reactor Safety Parameters serve the operator as guideposts, normalized to system calorimetrics, of unusual behavior. For example, given a xenon transient, and k(t)<1.0, a change in dρ/dt with an increasing DTL serves to warn of latent reactivity such that pulling control rods might not be advised. Also, use of Eq. (58) and associated axial modeling, could well use unsteady-state data, data say at 1 second intervals, to provide Eq. (58) enhanced sensitivity. Such computations are conducted, by option, in parallel with routine monitoring, with time intervals in seconds. They employ any of the techniques presented (i.e., full or partial integrations).

### Resolution of Unknowns and Optimization

As presented, four foundation equations, Eqs. (2ND), (1ST), (3RD) & (PFP) describe the nuclear power plant. These equations have four declared unknowns: Φ_{TH}, P_{GEN}, Q_{REJ} and m_{RV}. As presented, the four foundation and linear equations include Eqs. (2ND), (1ST), (3RD) & (PFP) which, upon resolution of their declared unknowns, allows a complete understanding of the nuclear power plant. The Preferred Embodiment includes declared unknowns: Φ_{TH}, P_{GEN}, Q_{REJ} and m_{RV}. This system of equations resolves the unknowns by routine matrix solution; routine, given these equations have been demonstrated to be completely independent, having a computed Rank of 4. Resolution of the unknowns by routine matrix solution means using the calorimetric Model to determine the computed average neutron flux (Φ_{TH}), shaft power to the electric generator (P_{GEN}), Turbine Cycle heat rejection (Q_{REJ}) and Reactor Vessel coolant mass flow (m Rv) simultaneously, and consistently, yielding a complete understanding of the nuclear power plant. From this Embodiment, variations to the declared unknowns provide a vehicle for improvements to nuclear safety. For example, the unknown flux can be replaced with [Φ_{TH} Σ_{F}] which is neutron density/second. Solving for [Φ_{TH} Σ_{F}] in the usual manner allows for on-line verification of affects on the core of an operator Controlling Neutron Density.

As previously discussed, these equations may also be embedded with Choice Operating Parameters (COP, Λₘ) which are: constrained by recognized limits; allow neutrino/antineutrino sensitivity studies; and act as a vehicle for fine-tuning. COPs are first assigned assumed values within applied limitations. Examples of limitations comprise: Eqs. (13), (35) & (43) and C_{FLX}, C_{FW} and C_{RV}. The selection of COPs is chosen by the user; the Preferred Embodiment includes the following:
Λ₁=B_{P} Square root of the pseudo buckling used in Eq. (PFP); cm⁻¹.
Λ₂=x_{RV} Steam quality leaving the RV, used for vendor matching; mass fraction.
Λ₃=x_{TH} Steam quality entering the TC's throttle valve; mass fraction.
Λ₄=ν̅_{LRV} Neutrino & antineutrino losses used in Eqs. (2ND) & (PFP); MeV/Fission.
Λ₅=h_{RCI} Enthalpy at core's entrance, used for debug and fine-tuning ; Btu/lbm.
Λ₆=Ψ_{LRV} If a COP, then used in Eqs. (2ND) &/or (PFP); MeV cm⁻² sec⁻¹.
Λ₇=Q_{RV-Loss} RV energy loss to environment, used for debug & fine-tuning ; Btu/hr.
Λ₈=Q_{SG-Loss} SG vessel energy loss to environment, for debug & fine-tuning ; Btu/hr.
Λ₉=Q_{TC-Loss} Non-Condenser TC energy loss, used for debug & fine-tuning ; Btu/hr.
   Obviously any Λₘ will affect its specific equation. However, all declared unknowns will be affected by any Λₘ, as dutifully apportioned from the matrix solution. By design, all equations employ only loss terms as constants in the augmented matrix. The above list of Εₘ is not encompassing, one skilled in the art can add, or subtract, based on unique designs and/or operating conditions. Selecting a set of COPs must depend on common understanding of a nuclear power plant and associated relationships between the neutronics, physical equipment and instrumentation viability.

To correct errors in COPs one of two methods may be employed: 1) apply judgement based on a nuclear engineer's experience with a particular signal (e.g., plot signals vs. time, compare multiple signal readings, talk to plant operators, etc.); or 2) use the preferred methods as taught herein. As to the viability of the NCV Method, the initial values of neutronic loss terms ν̅_{LRV} & Ψ_{LRV}, if selected as COPs, should be biased.

COP correction factors are determined through successive Calculational Iterations comprising multidimensional minimization and matrix analyses. Multidimensional minimization analysis minimizes an Objective Function in which a set of System Effect Parameters (SEPs) are driven to established values, termed “Reference SEPs”, by varying the set of COPs. The set of SEPs and their Reference SEPs, and the set of COPs are user selected. The key SEP is shaft generator power, P_{GEN} present in Eqs. (2ND), (1ST) & (3RD). Other SEPs include: flux, Φ_{TH}; the outlet core's specific exergy, g_{RVU}; the macroscopic fission cross section, Σ̅_{F}(t); and the principal NSSS mass flows, m_{FW} and m_{RV}. A summary of the SEPs, with reference values and user notes follows. The Preferred Embodiment is to use only Δλ_{GEN}, at least until the system is well understood. The system operator must use Δλ_{FW} and/or Δλ_{RV} with great caution. Principal flows are commonly selected by operators. However, if used, their reference signals must have an established consistency over the load range of interest.

Δλ_{GEN}≡(P_{GEN}−P_{GEN-REF})/P_{GEN-REF} See description of P_{UT} per Eq. (8) (61)

Δλ_{FLX}≡(Φ_{TH}−C_{FLX}Φ_{FC})/(C_{FLX}Φ_{FC}) The C_{FLX} is based on initial FC testing. (62)

Δλ_{RVU}≡(g_{RVU}−g_{RVU-REF})/g_{RVU-REF} Use in Eq. (1ST) via Eq. (5) (63)

Δλ_{CS}≡(Σ̅_{F}−Σ̅_{F-REF})/Σ̅_{F-REF} Based on-line NFM, per Eqs. (22) & (23). (64)

Δλ_{FW}≡(m_{FW}−C_{FW}m_{FW-REF})/(C_{FW}m_{FW-REF}) For debug, or on-line with great confidence. (65)

Δλ_{RV}≡(m_{RV}−C_{RV}m_{RV-REF})/(C_{RV}m_{RV-REF}) For debug, or on-line with great confidence. (66)

Examples of Reference SEPs include P_{GEN-REF}, C_{FLX}Φ_{FC}, etc. Again, the list of SEPs is not encompassing, one skilled in the art can add, or subtract, based on designs and operating conditions; this is especially true if, over time, a given signal has developed unquestioned consistency and reliability. The Reference g Rvu _{—} REF is included for benchmarking against vendor data.

The NCV Method uses multidimensional minimization analysis which drives an Objective Function, F(\vec{x}), to a minimum value (ideally zero), by optimizing SEPs. Although COP values (Λₘ) do not appear in the Objective Function—by design—they directly impact SEPs through the calorimetric Model. After iterations between the matrix solution and minimization analysis, the preferred SEP of turbine shaft power leaning to electrical generation, is driven towards its Reference SEP and thus the computed parameters of Φ_{TH}, Q_{REJ}, m_{RV} and P_{GEN} are: 1) internally consistent, and 2) form the nexus between neutronics and calorimetrics.

The Preferred Embodiment of NCV's Verification Procedures is multidimensional minimization analyses as based on the Simulated Annealing method by Goffe, et al. Goffe's Simulated Annealing is a global optimization method, driven by Monte Carlo trials, as it distinguishes between different local optima. Starting from an initial point, the algorithm takes a step and the Objective Function is evaluated, including the matrix solution of Eqs. (2ND), (1ST), (3RD) & (PFP). When minimizing the Objective Function, any downhill step is accepted and the process repeats from this new point. An uphill step may be accepted. Thus, it can escape from local optima. This uphill decision is made by the Metropolis criteria. As the optimization process proceeds, the length of the steps decline and the algorithm closes in on a global optimum. Since the algorithm makes very few assumptions regarding the Objective Function, it is quite robust with respect to non-linear problems as found in Eq. (PFP) when optimizing on buckling. The reference is: W. L. Goffe, G. D. Ferrier and J. Rogers, “Global Optimization of Statistical Functions with Simulated Annealing”, J. of Econometrics, Vol.60, No. 1/2, pp.65-100, January/February 1994.

The following is the Objective Function as found to work best with Simulated Annealing. The Bessel Function of the First Kind, Order Zero has shown to have an intrinsic advantage for rapid convergence in conjunction with the Annealing's global optimum procedures.

F(\vec{x})=Σ_{k∈K}{K−[J₀(Δλ_{GEN})]^{MC}^{_{Λm}}−[J₀(Δλ_{FLX})]^{MC}^{_{Λm}}−[J₀(Δλ_{RVU})]^{MC}^{_{Λm}}−[J₀(Δλ_{CS})]^{MC}^{_{Λm}}−[J₀(Δλ_{FW})]^{MC}^{_{Λm}}−[J₀(Δλ_{RV})]^{MC}^{_{Λm}}}ₖ (67)

In Eq. (67), MC_{Λm} is termed a Dilution Factor, here assigned individually by COPs resulting in greater, or less, sensitivity. Dilution Factors are established during commissioning tests of the NCV Method, adjusted from unity. In Eq. (67) the symbol [Σ_{k-K}] indicates a summation on the index k, where k variables are contained in the set K defined as the elements of \vec{Λ}. For example, assume the user has chosen the following for a PWR:
Λ₁ is to be optimized to minimize the error in Δλ_{GEN} & Δλ_{FLX}, K₁=2;
Λ₄ is to be optimized to minimize the error in Δλ_{GEN}, K₂=1;
Λ₉ is to be optimized to minimize the error in Δλ_{GEN}, K₃=1.
   Therefore: \vec{Λ}=(Λ₁, Λ₄, Λ₉), K={Λ₁, Λ₄, Λ₉}; \vec{x}=(x₁, x₂, x₃); x₁=Λ₁, x₂=Λ₄, x₃=Λ₉; and it is assumed during commissioning that: MC_{Λ1}=0.72, MC_{Λ4}=1.20 & MC_{Λ9}=1.00. The above reduces:

F(\vec{x}={2−[J₀(Δλ_{GEN})]^{MC}^{_{Λ1}}−[J₀(Δλ_{FLX})]^{MC}^{_{Λ1}}}+{1−[J₀(Δλ_{GEN}(]^{MC}^{_{Λ4}}}+{1−[J₀Δ(Δλ_{GEN})]^{MC}^{_{Λ9}}} (68)

Upon optimization, COP correction factors, Cₘ, for a Λₘ are determined simply as: Cₘ=Λₘ₋ₖ/Λₘ₋₀, for the k^{th} iteration. Note that the only output from the computer program performing these computations, ERR-NUKE, are correction factors.

### INDUSTRIAL APPLICABILITY

The above DETAILED DESCRIPTION describes how one skilled can embody its teachings when creating a viable NCV Method. This section describes its industrial applicability, that is, how to physically enable the NCV Method at a nuclear power plant means: how to configure its computer (the Calculational Engine); how to process plant data; how to configured its governing equations for pre-commissioning and, separately, for routine operations; and, most importantly, presents specific recommendations as to what the plant operator needs to monitor (i.e., to absorb NCV output information and to act upon that information). Enablement is presented in four sections: The Calculational Engine and Its Data Processing, Clarity of Terms, a summary Final Enablement, and Detailed Description of the Drawings which adds detail as to a typical installation including use of the PFP Model.

### Calculational Engine and Its Data Processing

The initial enablement of this invention involves three important aspects of NSSS on-line monitoring: 1) how data is collected; 2) how it is presented for analyses, that is reducing and averaging techniques employed; and 3) the nature of the monitoring computer. All power plants process instrumentation signals using a variety of signal reduction devices, FIGS. 1 & 2 Item 400. These devices depend on: the nature of the signal (analog, digital, pneumatic, on/off switches, potentiometers, etc.); the physical location of instruments; and the physical location of the signal reducing devices (e.g., cable runs, local environment, security, etc.). Once processed by the signal reduction devices, the information becomes data which carries a time-stamp (i.e., the time the signal was acquired). At issue is how to synchronize such data, originating from different sources, each source possibly having a different time-stamp (and typically does). If data is not synchronized, the user is guaranteed to violate continuity. The Preferred Embodiment is to use the teachings of '358 which produces a set of synchronized data having the same time stamp. The second problem is how the set of synchronized data is reduced and averaged before it is presented for analyses. Reduction comprises units conversion, gauge pressure and head corrections, and the like. The NCV Method, through its NUKE-EFF program provides options of using running averages of data over 5, 15, 20, 25 and 30 minutes. The data acquisition process, using the set of synchronized data, forms 1 minute averages of each data point, relying on, say, 1 signal input each 10 seconds (or faster for certain RV data), averaging this data over a minute, and then forming a running average (over, say, 15 minutes). These times are user selected. This means each update processes the following 15 minutes of data (e.g., from 10:00 to 10:15, then 10:01 to 10:16, etc.). The choice of running averages is left to the plant engineer knowing the fluid transport times through the NSSS. Typically a unit of fluid passes from the TC's throttle valve to its final feedwater connection in 12 to 20 minutes (given long transport times in the condenser hot well and feedwater heat drain sections). From final feedwater to RV (or SG inlet) requires 1 to 3 minutes. If the operator chooses a shorter time for averaging than the fluid transport time, he/she risks aliasing data. The PFP Model, when optioned, runs its reactor dynamics in parallel with the synchronized.

The third aspect of power plant on-line monitoring is the nature and function of the computer (FIG. 1 & 2, Item 420) having a processing and memory means to implement the NCV Method. The Preferred Embodiment is to commit a dedicated, single-use computer to NCV tasks. This computer is termed a “Calculational Engine”. The Calculational Engine can be more easily safeguarded from foreign mischief. Its inputs and outputs, by design, are under the control of plant engineers (i.e., in FIG. 1 & 2 Items 410 & 43). Also, by design, the Calculational Engine will not be exposed to any non-NCV Method computer program, or to internet communication, or to any non-plant information.

To summarize, the NCV Method comprises three parts: a “Nuclear Model”; a “Calorimetric Model” and a “set of Verification Procedures”. The Nuclear Model results from acquiring a set of “Off-Line Operating Parameters”. The set of Off-Line Operating Parameters comprise: geometric buckling; static equipment data (e.g., throttle valve design pressure drop, L_{Mech}, L_{Elect}, vendor Turbine Kit, and similar data); equivalent data contained in TABLE 1 as appropriate; neutron migration area; macroscopic cross sections; physical dimensions of the core; fuel pin and fuel assembly dimensions; nuclear fuel design parameters; the limitations for Eqs. (13), (35) & (43) as appropriate; off-line PFP Model data comprising an exergy profile as a function of axial position; operating limitations (e.g., found in 10CFR50.36) including the Regulatory Limit on Core Thermal Power Limit and the acceptable Operating Tolerance Envelope; and similar such data. Much of the aforementioned data may be obtained from Nuclear Fuel Management (NFM) computations which is the Preferred Embodiment; and/or it may be obtained from common references, vendor specifications, vendor records, plant historical records, laboratory research, etc.

The calorimetric Model results from acquiring a set of equations comprising nuclear and thermodynamic terms and a set of On-Line Operating Parameters comprising input to the set of equations. The set of equations comprising nuclear and thermodynamic terms, analytically describes the nuclear power plant using both First and Second Laws of thermodynamics with the objective of a thermodynamic solution of the nuclear power plant comprising a set of Thermal Performance Parameters. The set of On-Line Operating Parameters comprises: determining thermodynamic properties (input/outputs) associated with the RV, SG (if applicable), TC components including the MSR and major equipment, said properties are determined from measured pressures, temperatures, fluid quality (measured or assumed), and the like; measuring electric power; measuring pump motive powers (P_{RV-k} & E_{TC-k}; confirming the reliability and consistency of a Reference SEP if used; acquiring indicated mass flows including m_{RV}, m_{FW} and m_{CD} if available; determining drain flows from the MSR;

measuring the inlet pressure to the LP Turbine; and similar such data. On-Line Operating Parameters involving neutronics could result from on-line NFM computations embedded in the calorimetric Model, which is the Preferred Embodiment. Whether NFM computations are part of the calorimetric Model, or not, is dependent on the nature of the plant, its stability and load demands.

The set of Verification Procedures results from acquiring a set of plant SEPs with a set of corresponding Reference SEPs resulting in a set of paired SEPs, and a method of minimizing differences between the paired SEPs. The sets of plant SEPs and Reference SEPs are presented in Eqs. (61) thru (66) with associated teachings. The Preferred Embodiment of the method of minimizing differences, as taught, employs multidimensional minimization analysis based on Simulated Annealing; this is summarized through its Objective Function, Eq. (68), and associated discussion.

### Clarity of Terms

In the context of describing this invention, the words “acquiring” and “using” mean the same. The word “acquiring” is sometimes used for readability. They both mean: to take, hold, deploy or install as a means of accomplishing something, achieving something or acquiring the benefit from something; the “something” is the NCV Method or its equivalence. Also, these words do not imply ownership of any thing or to any degree concerning the NCV Method.

As used herein, if used, the root words “obtain”, “determine” and “establish”, and their related derivatives (e.g., “obtaining”, “determining” and “establishing”) are all defined as taking a certain action. The certain action encompasses to directly measure, to calculate by hand, to calculate using a programmed computer, to authorize calculations using a programmed computer at a facility controlled by the authorizer, to make an assumption, to make an estimate, and/or to gather from a database.

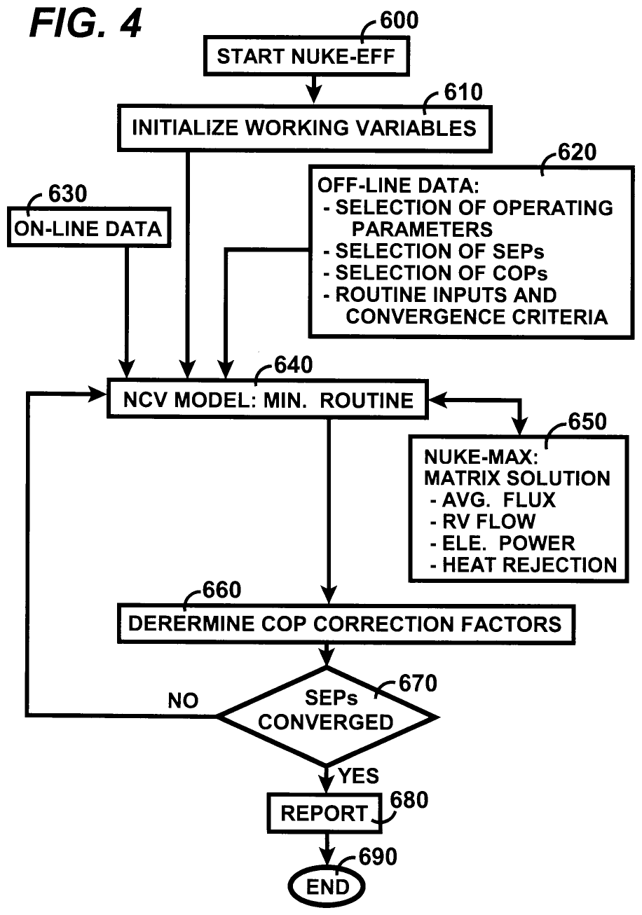

As used herein, the words “monitoring” or “monitored” are meant to encompass both on-line monitoring (i.e., processing system data in essentially real time) and off-line monitoring (i.e., computations involving static data). A “Calculational Iteration” or “monitoring cycle” is meant to be one execution of the processes described in FIG. 4 comprising: acquiring data, the matrix solution, minimization analysis, etc.

As used herein, the words “Secondary Containment” refers to a vessel used to reduce radiation release to the environment. Inside a PWR's Secondary Containment comprises the Reactor Vessel (RV), the Steam Generator(s) (SG), coolant pump(s), the pressurizer and miscellaneous safety equipment. Inside a BWR's Secondary Containment comprises the RV, coolant pump(s), and miscellaneous safety equipment. The Secondary Containment defines the physical boundary for all major equipment other than the Turbine Cycle. Within the RV its equipment comprises the nuclear core (or “core”), control rods and supporting structure and miscellaneous core safety systems. The typical core comprises hundreds of fuel assemblies. Each fuel assembly comprises: fuel pins positioned axially by a number of “grid spacers”; flow nozzles are positioned at the top and bottom, the bottom supporting fuel pin's weight; hollow tubes and/or spaces are designed for control rod insertion; and axial structures which mechanically connect the flow nozzles. For the typical PWR & BWR each fuel pin comprises enriched uranium, as UO₂, placed in a metal tube (termed a fuel pin's “clad”), see FIG. 3.

As used herein, the words “Turbine Cycle” (TC) is defined as both the physical and thermodynamic boundary of a Regenerative Rankine Cycle. Specifically a typical Turbine Cycle encompasses all hardware between the inlet pipe connected to the TC's throttle valve, the electrical generator (its output terminals), and the contractual end of the feedwater pipe downstream from the TC's highest pressure feedwater heater.

As used herein, the word “indicated” when used in the context of data originating from the thermal system is herein defined as the system's actual and uncorrected signals from a physical process (e.g., pressure, temperature or quality, mass flow, volumetric flow, density, and the like) whose accuracy or inaccuracy is not assumed. As examples, a system's “indicated mass flows” or its “indicated Reactor Vessel coolant flow” or its “indicated Turbine Cycle feedwater flow” denotes system measurements the accuracy of which is unknown (they are “as-is”, with no judgement applied). Such indicated measurements are said to be either correctable or not. If not correctable it may be that their corresponding computed value, tracks the indicated value over time. For example, in the case indicated RV coolant flow, when used as a SEP, it may be shown that NCV computed flow tracks the indicated.

As used herein, the words “programmed computer” or “operating the programmed computer” or “using a computer” are defined as an action encompassing either to directly operate a programmed computer, to cause the operation of a programmed computer, or to authorize the operation of a programmed computer at a facility controlled by the authorizer.

As used herein, the words “calorimetric” and the “laws of thermodynamics” mean the same in context. The “laws of thermodynamics” as used herein consist of the First and Second Laws of thermodynamics. The words “thermodynamic formulation” mean the process of forming a set of equations including supporting logic which allows mathematical description of the nuclear power plant. For a fission power plant the thermodynamic formulation comprises, as an example, the following four equations: Eqs. (2ND), (1ST), (3RD) & (PFP) which employ two First and Second Law applications each. For a fusion system, a thermodynamic formulation comprises Eq. (36) which is a statement of the Second Law principle that for any non-passive process: Ik>0.0 per Eq. (33); Eq. (36) must be satisfied to conserve this principle.

As used herein, the meaning of the word “quantifying” in the context of “quantifying the operation of a nuclear power plant” is taken in the usual dictionary sense, meaning “to determine or express the quantity of . . . ”; for example, at a minimum, what is being “quantified” is a “complete understanding of the nuclear power plant” and/or “improving operations of the nuclear power plant” and/or “the ability to understand the nuclear power plant with improved confidence given use of verified results”. As used herein, the meaning of the word “instigating” is herein defined (via Google's Oxford Languages) as to “bring about or initiate (an action or event)”.

Teachings leading to Eqs. (46) & (48), and then Eq. (PFP), present new thermodynamic descriptions of neutronic and coolant exergy flows and, given their partial vertical integration necessitated to achieve asymmetry, leads to equations which improve the NCV Model given its addition. This allows power to be declared an unknown, thereby not reducing the matrix's Rank relative to the number of independent equations. Eq. (5), given its Inertial Conversion Factor, demonstrates how First and Second Law formulations can be paralleled without compromising the computation of an absolute flux. Thus using the Inertial Conversion Factor, statements about “nuclear energy”, “energy distribution of flux”, and such usage found in popular literature may now be understood to mean, correctly, “nuclear exergy”, “exergy distribution of flux”, and so-forth.

Fusion involves ¹H, ²H (D), ³H (T), ³He, ⁷Be, and other isotopes whose fusion produces neutrinos and other radiation. This invention teaches that an irreversible loss associated with nuclear inertial processes, in particular neutrino and/or antineutrino production—whether fission or fusion—must be properly accounted via Eq. (33). Eq. (33) is a statement of the Second Law principle, Ik>0.0. This statement allows judgement of the viability of a thermal system to operate. When neutrino and antineutrino exergies are properly accounted, the Second Law is conserved, allowing the computation of a non-frivolous absolute flux.

A common practice with reactor design is to separate gamma heating of the reactor coolant from exergy liberated within the fuel pin (principally, exergy associated with dispersion of fission products within the fuel). The fraction of such heating relative to TABLE 1's F13 release, is typically taken as 2.6%. One reason for such separation is to compute the fuel pin's centerline temperature with additional accuracy (producing a lower temperature). Given the objectives of the NCV Method, internal pin temperatures are not an immediate objective. Of course, the source of gamma heating is apportioned from the recoverable release, completely accounted by: [g_{RVU}(T_{Ref})−g_{RCT}(T_{Ref})]. However, the PFP Model is ideal for fuel pin studies, after system solution, given the average flux (thus fission rate) and coolant mass flow would have been fully verified.

Although the present invention has been described in considerable detail with regard to certain Preferred Embodiments thereof, other embodiments within the scope and spirit of the present invention are possible without departing from the general industrial applicability of the invention. For example, the descriptions of this invention assume that a nuclear reactor's coolant is light water, however the general procedures of this invention may be applied to any type of fluid. Examples of other fluids are: mixtures of water and organic fluids, organic fluids, liquid metals, and so forth. The descriptions of this invention assume that the nuclear fuel is enriched uranium, formed as UO₂; however, the general procedures of this invention apply to any fissile material including thorium, and breeder configurations. Teachings on exergy flow from fission has placed emphasis on the thermal neutron spectrum. Note that Eq. (5) is applicable for a breeder or fast reactor given the neutron flux required for ²³⁸U capture is generated by thermal fission. The general theme and scope of the appended CLAIMS.

This stated, the following paragraphs also present the best enablement for pre- and post-commissioning operations.

### Final Enablement

The enablement of this invention is principally accomplished through both implementation of the Calculational Engine and data processing describe above, and, as a separate task, manipulation of COPs and associated SEPs during pre-commissioning. Pre-commissioning techniques are summarized below. The Preferred Embodiments of this invention have been described in considerable detail for purposes of describing the various modes of this invention, they are not intended to limit the invention. Indeed, the various modes establish guideposts, structures, for one skilled in the art to install, to implement, to manipulate this invention, and to use this invention in every way and to every extent possible, limited only by the appended CLAIMS. This stated, the following paragraphs also present the best mode, its Preferred Embodiment, for post-commissioning operations.

The teachings have developed four equations descriptive of the nuclear power plant. Studies have revealed that these equations offer the best mode for monitoring the most common nuclear power plants, PWRs & BWRs. However, given the complexity and variations of nuclear power plant design, for example a breeder, the treatment of neutronics must correspond. In like manner, this disclosure and Patent '146 teaches the Second Law treatments of a variety of equipment.

Key to both pre- and post-commissioning is the manipulation of governing equations. These equations are summarized below, but stylized for readability. The constants Aᵢᵢ, Bᵢᵢ, etc. represent coefficients to the declared unknowns. Nomenclature is referenced to Eq. (2ND), whose coefficients are designated Aᵢᵢ, Eq. (1ST) as Bᵢᵢ, Eq. (3RD) as Cᵢᵢ and Eq. (PEP) as Dᵢᵢ. The important flux terms, Φ_{TH} & Ψ_{LRV}, are noted, for clarity, with coefficient functionalities. The augmented matrix comprises conventional loss terms, Lⱼⱼ. Note that L_{D}=0.0. As an unique design feature of the NCV Method, Lⱼⱼ and m_{RV} coefficients all carry unique values. At the user's option, COPs might include: ζ₁=B_{P}, Ε₄=ν̅_{LRV}(t), Λ₆=Ψ_{LRV}, and/or [ν̅_{REC}(t)+ν̅_{LRV}(t)] replaced with a constant ν̅_{TOT}. COPs involving purely thermal parameters, applicable for all equations, include Λ₂, Λ₃, Λ₅, Λ₇, Λ₈ and Λ₉.

A₁[ν̅_{REC}(t)+ν̅_{LRV}(t)]Φ_{TH}+A₂P_{GEN}+A₃Q_{REJ}+A₄m_{RV}=L_{A}+A₁Ψ_{LRV} (2ND′)

B₁[ν̅_{REC}(t)]Φ_{TH}+A₂P_{GEN}+B₃Q_{REJ}+B₄m_{RV}=L_{B} (1ST′)

A₂P_{GEN}+B₃Q_{REJ}+C₄m_{RV}=L_{C} (3RD′)

(2D₁/B_{P})[ν̅_{REC}(t)+ν̅_{LRV}(t)]Φ_{TH}+D₄m_{RV}=(2D₁/B_{P})Ψ_{LRV} (PFP)

It is the obvious intent of the above arranged equations, given use of Λ₁, Λ₄, Λ₆ and ν̅_{TOT} (not shown) to tax the matrix solution. However, after a pre-commissioning phase, involving sensitivity studies and benchmarking, the system of equations will achieve, for the common nuclear power plant, a robust nexus between neutronics and calorimetrics.

The following is best mode practice for pre-commissioning, as with any large computer system, is to step through the simplest of exercises, ending with the best mode for post-commissioning. The following Steps are the best mode for pre-commissioning:
1a) Using Eqs. (2ND), (1ST), (3RD) & (PFP) elect no COPs and set all Λₘ to constants when establishing the Nuclear Model; set all temporal data associated with the Nuclear Model to constant inputs. This step will produce from the solution matrix: P_{GEN}, Φ_{TH}, Q_{REJ} and m_{RV}. If all are reasonable, incorporate variable (or automated) Nuclear Model and calorimetric Model data; repeat test runs; proceed to Step II upon success.
1b) If Q_{REJ} and/or the computed m_{RV} (and/or m_{FW}) are unreasonable, a simple method for debug is to temporally use Λ₇, Λ₈ and Λ₉ in order to discover which sub-system, RV, SG or TC, is the most sensitive for correcting. Basically one is replacing a unknown fault with a sub-system loss. Repeat these sub-Steps, until reasonable answers are obtained.
II) Use the equations from Step I, but now adding Λ₁ optimizing Δλ_{GEN}; adjust MC_{Λ1} to improve computer execution times and to establish sensitivities. Finally, adjust C_{M} of Eq. (43) to reduce search times. Caution: the buckling is extremely sensitive, if Eq. (43) is exceeded all inputs need to be reviewed.
III) Use the equations from Step I, but set Λ₁ to the value found in Step II; add Λ₄, optimizing on Δλ_{GEN}; adjust MC_{Λ4} to improve computer execution times; reasonable limits per Eq. (35) must be established. If ν̅_{REC} is questioned, uncertainties most likely are associated with Non-Fission Capture (TABLE 1, Col. F6). Benchmarking should begin with virgin fuel data.
IV) Repeat the above process, proceeding with more complexity by adding thermal COPs to establish additional sensitivities and benchmarks. It is also important to add a mix of irreversible loss terms, thus using Λ₄ versus a constant. The end objective is to use Λ₁ & Λ₄ optimizing Δλ_{GEN}, with resolved MC_{Λm} values. Optimizing on Operating Parameters other than P_{GEN} must proceed with great caution, as taught. If the plant operator has established a long history of consistently monitoring feedwater flow over the load range, and it matches the computed (perhaps with a constant off-set) then consideration of using Δλ_{FW} can be made; this will speed convergence. Note, the NCV Method allows for corrections to the indicated TC and RV mass flows.
V) An important final pre-commissioning step is to evaluate all irreversible loss terms; i.e., conventional vessel and radiation losses. The matrix solution sets all such terms as constants in the augmented matrix (COPs are varied apart from the matrix solution). In addition to vessel losses, a design review of the resolved Λₘ parameters is required. Questions must arise as to the appropriateness of ν̅_{PNU} and ν̅_{DNU} values of TABLE 1. Given the NCV approach, given its treatment of the inertial process, the lack of direct flux measurement and without direct neutrino measurements, Step V must rely on engineering judgement. By NCV design, irreversible losses will impact the computed buckling, Λ₁, thus Eq. (43) has great import.

The above Steps are designed for enablement before commissioning. To enable the NCV Method in achieving the best mode post-commissioning, computer installation, data management and pre-commissioning all have obvious import. The following Steps VI & VII, as routine practice, is the best mode for on-line application of the NCV Method.
VI) Select Eqs. (2ND), (1ST), (3RD) & (PFP), adding the resolved Λ₁ & Λ₄ values as constants. It is good practice to optimize Λ₉ by minimizing the error in Δλ_{GEN}, and then comparing to changes in TC's FCIs.
VII) At every completed cycle of the Calculational Engine, the NCV Method proceeds with its set of Verification Procedures. These Procedures produce a “set of verified Thermal Performance Parameters” which must be examined for both absolute values and their trends over time. Through successful Verification Procedures, the NSSS operator will become satisfied that the system is well understood. Thus changes in the set of verified Thermal Performance Parameters, as believable results, become critically important for improved nuclear power plant operations. They simply allow the operator, for the first time, to make informed decisions, having an established record of verification (e.g., Δλ_{GEN}≈0.0).

A sampling of the set of verified Thermal Performance Parameters, comprise the following list, noting that both SEPs and their associated Reference SEPs are presented with suggested observations. The parameters described in Eqs. (14) & (37) are a portion of the set of verified Thermal Performance Parameters. The user of the NCV Method is advised to plot the set of verified Thermal Performance Parameters over time, reviewing the set of verified Thermal Performance Parameters for temporal trends and making changes to NSSS operations based on those temporal trends. Examples are obvious to any skilled NSSS operator; for example if FCI_{power} decreases, the operator will observe higher losses within the NSSS, located by reviewing all non-power FCIs such as FCI_{Loss-MSR}, FCI_{Loss-HP}, FCI_{Loss-FWH5}, etc. The important parameters, for best mode embodiment, are marked with *.
*FCI_{power} as a function of time;
*FCI_{RV} as a function of time;
FCI_{SG} as a function of time;
FCI_{Loss-k} for the TC as a function of time (MSR, HP and LP turbine, FW heaters (FWHj), etc.;
*P_{GEN} and P_{GEN-REF} must match as a function of time;
*Core Thermal Power as a function of time, with consideration of the Regulatory Limit;
η_{SYS} as a function of time;
η_{TC} as a function of time;
*ϵ_{SYS} as a function of time;
*ϵ_{TC} as a function of time;
Φ_{TH} and [C_{FLX}Φ_{FC}] as a function of time, tracking with constant off-set over load changes;
*m_{FW} and [C_{FW}m_{FW-REF}] as a function of time, tracking over each other;
*m_{RV} and [C_{RV}m_{RV-REF}] as a function of time, tracking over each other;
a scaled P GEN and Q REJ as a function of time, will track each other with variable off-set;
*compare computed √buckling if using as a COP, Λ₁, to limitations imposed by Eq. (43); and
*ν̅_{LRV} as a function of time will yield a slightly changing slope with burn-up.
   The operator must be aware that the NCV Method produces consistent absolutes: an absolute flux and power generated will always be consistent with computed reactor coolant flow, the resultant feedwater flow, etc. Thus if power agrees with the measured, and feedwater flow trends downward, then recent operational changes have improved thermal effectiveness; refer to the TC's FCIs. Such examples are endless given a complex NSS System, the above plots provide mechanisms for successful monitoring.

### DETAILED DESCRIPTION OF THE DRAWINGS

The descriptions and implied teachings presented in the following sections are considered examples of the principles of the invention and are not intended to limit the invention. Rather, said descriptions and implied teachings establish guideposts, a structure, for one skilled in the art to install, to implement, to manipulate, and to use the invention in every way and to every extent possible, limited only by the CLAIMS herein.

FIG. 1 is submitted as a generic representation of a PWR. Included within FIG. 1 is a representation of the data acquisition system required for the NCV Method, Items 400 through 460. The Reactor Vessel (RV) 100 contains the nuclear core 104, and the steam separator 102 if used. For a PWR control rods enter the core from the top of 104, thru 100 and 102. Coolant flow enters via pipe 154, flows down the outer annulus of the RV 155, then flowing upwards through core, through the separator, exiting to pipe 150. The pressurizer is Item 120 used for volume control. Pipe 150 enters the Steam Generator (SG) 140, flowing through a tube-in-shell heat exchanger 151. Note that two SG designs are commonly employed: the U-tube design producing a saturated working fluid exiting via pipe 160 (as shown), or a straight-thru design which produces a superheated working fluid at 160. After heating the working fluid, the RV coolant is returned 153 to the main coolant pump 130 and to the RV via pipe 154.

FIG. 1 and FIG. 2 contain the same representations of the Turbine Cycle (TC), presented generically by Items 500 through 590. The presented TC is greatly stylized, typically a nuclear TC is: 1) more complex than the reactor per se; and 2) more complex than a typical fossil-fired system (e.g., the use of additional turbine extractions and thus feedwater heaters, the use of a Moisture Separator Reheater (MSR) between the High Pressure (HP) and Low Pressure (LP) turbines, etc.). Working fluid flow enters the throttle valve 500 and then the turbine 510 via 505. The nuclear turbine typically comprises a HP and many double-flow LP turbines. The generator is Item 515, whose gross output, P_{UT}, is measured at terminals 517; its shaft power, symbolically designated 519, is P_{GEN}. The LP turbine exhausts via 520 to the Condenser 535. Extractions are generically described by 530 & 525, heating numerous HP feedwater heaters 560, and numerous LP heaters 545. The condensate flow 540, to a FW pump (or pumps) 550, being returned to the SG via 570. The shell-side drains of the feedwater heaters, 580 & 590 flow to the condensate system or are pumped forward with MSR drains.

FIG. 1 and FIG. 2 contain the same representations of the apparatus of this invention showing a computer receiving acquired system data, such as On-Line Operating Parameters, from a data acquisition system and producing output reports via a programmed computer. Specifically the represented power plant in FIG. 1 and in FIG. 2 is instrumented such that On-Line Operating Parameters (450 and 460) are collected in a data acquisition device 400. Within the data acquisition device 400 said data is typically converted to engineering units, averaged and/or archived, resulting in a set of acquired system data 410. Examples of said data acquisition device 400 comprise a data acquisition system, a Distributed Control System, an analog signal to digital signal conversion device, a pneumatic signal to digital signal conversion device, an auxiliary computer collecting data, or an electronic device with data collection and/or conversion features. After processing, the data acquisition device 400 transfers the set of acquired system data 410 to a programmed computer 420, termed a “Calculational Engine”, with a processing means and a memory means. The processing vehicle for transfer of the set of acquired system data 410 may be either by wire or by wireless transmission. The Calculational Engine 420, operates with a set of programmed procedures descriptive of the NCV Method of this invention, comprising, at least, complete neutronic and thermodynamic balances of the Reactor Vessel (RV) and its components, and a thermodynamic balance of the Turbine Cycle (TC); it is generally diagramed in FIG. 4. Specifically the set of programmed procedures using the NCV Method, determines a neutron flux, an electrical generation, a RV coolant mass flow (and thus a TC feedwater mass flow), and a heat rejection at the condenser. As taught in the SPECIFICATION, these unknowns are contained in the chosen set of equations and solved by matrix solution (see 650 in FIG. 4). The computer 420, operating with the programmed procedures descriptive of this invention, also may determine any one or all of the following as taught herein: First Law thermal efficiencies of the system and the Turbine Cycle; Second Law thermal effectivenesses of the system and the Turbine Cycle; nuclear bucking; neutrino and/or antineutrino radiation; Fission Consumption Indices; and other neutronic and calorimetric data. The energy flow to the working fluid derives from TC instrumentation signals, and the feedwater mass flow and the heat rejection at the condenser. Said signals are transmitted to the data acquisition device 400 for processing. The determination of the steam enthalpy and exergy from pressure and temperature or quality data, and determination of feedwater enthalpy and exergy from pressure and temperature data may occur within 400 or may occur within the Calculational Engine 420. Note that all specific exergy values are determined as: g=f(P,h,T_{Ref}) in compliance with Eq. (5). The Calculational Engine 420 contains in its memory device a set of Off-Line Operating Parameters. Computer output Item 430, produced from 420, comprises any portion of information presented in this disclosure, processed and distributed via 440. Output 430 may be made available to the system operator, engineer and/or regulatory authorities as paper reports printed on a printer, or may be made available in electronic or visual forms via 440 or using the Calculational Engine 420, or its clone. In summary, this invention teaches to operate and/or use the Calculational Engine 420 to obtain a complete understanding of a nuclear power plant and to provide information 440 as to how to improve the nuclear power plant.

FIG. 2 is submitted as a generic representation of a BWR. The Reactor Vessel (RV) 200 contains the nuclear core 204, and the steam separator 202. For a BWR, control rods enter the core from the bottom of 204. Coolant flow enters via pipe 254, flows down the outer annulus of the RV 255, then flows upwards through core, through the separator 202, exiting to pipe 250. Pipe 250 enters the TC at 500. After passing through the TC, the working fluid is returned to the RV via items 570, 230 & 254.

FIG. 3 and FIG. 5 illustrate an important portion of this invention, that is, the Pseudo Fuel Pin Model (PFP). As described, the PFP thermodynamically models an average fuel pin. In FIG. 3 its radial cross section is listed as 350 to 390, and axially 320; no scale is used. The pin is composed of axially stacked fuel pellets 390, typically consisting of enriched UO₂ with an outside radius (r₀) at 380. The stacked fuel pellets are placed in a tube, termed “cladding” or “clad” which is typically a zirconium or stainless steel alloy with an ID at 370, OD at 360. The average hydraulic area bearing coolant flowing axially, is an annulus with an ID at 360, OD at 352. The area of the annulus 350 is established by taking the total area of the core, less the fuel pin area given its OD at 360, less the core's structural area, resulting in 350. The PFP's height is the active core's height, from its entrance 342 to exit 346, given by 2Z.

FIG. 3 also clarifies the nomenclature used in Pseudo Fuel Pin Model's neutronics treatment. The (z) axial origination 334 is used for cosine integration and positive upwards from the centerline 328 to 346, negative from 328 to 342. The (y) axial origination 332 is used for Clausen Function integration and positive upwards from 342 to the top of the core 346. In summary, the core's entrance 342 is at: z=−Z and y=0.0, while the centerline 328 is at: z=0.0 and y=Z. The outlet 346 is at: z=+Z and y=2Z. The average neutron flux cosine profile is symmetric about 328. Flux buckling effects are noted by the distance 321, zero flux is assumed at 343 and 347. Further, as taught, the Differential Transit Length (DTL) is item 331, a distance 330 from the core's entrance. Note that the Clausen's peak, for a typical 144 inch core, is found at: y̅=47.134 inches.

FIG. 4 is a block diagram of the computer program NUKE-EFF, the principal program used to implement the NCV Method. The NUKE-EFF program and its supporting sub-programs represent the processing means and a memory means described as Item 420, the Calculational Engine in FIG. 1 and FIG. 2. The computer 420 is programmed with procedures following the NCV Method of this invention. Within FIG. 4 Item 600 starts the program. Item 610 initializes working variables and sets constants such as energy and exergy conversions, nuclear constants, and the like. Item 620, although not part of the NUKE-EFF program per se, represents a general data initialization step conducted by the user, and a necessary work task which involves setting Off-Line Operating Parameters, SEPs, COPs and miscellaneous inputs required by the NCV Method given the uniqueness of the particular power plant. This results in the Nuclear Model Item 620. 620 also represents establishing NFM Method data including fuel pin simulations which define burn-up characteristics [i.e., Megawatt-Days per Metric-Tonne-Uranium (metal), MWD/MTU], data collection and organization, and routine set-ups of all computer programs.

FIG. 4's on-line data is Item 630, that is data acquired and collected in real time. On-line data includes On-Line Operating Parameters, COPs from input or the previous monitoring cycle, updates of reference SEPs, and the like. 630 typically processes over 200 signals from the NSSS. Item 630 also includes signal conversions as required (e.g., pressures from psi-gage to psi-absolute, temperatures from ° F. to ° R., to ° K., and the like). Item 640 as a portion of the NUKE-EFF computer program: organizes inputs from 610, 620 and 630; prepares input for the NUKE-MAX computer subroutine which preforms the matrix solution of the best mode set of equations; checks return values; and miscellaneous computations. The acquiring of the aforementioned on-line data, the use of selected equations and COPs (e.g., using the best mode set of equations); the matrix solution, results in the calorimetric Model. The work of NUKE-EFF 640 includes the important step of determining corrections factors to the chosen COPs, as Item 660. Item 640 also includes Fission Consumption Index (FCI) computations associated with the NSSS and its equipment including the nuclear core and the TC and its equipment. FCI computations include all components and processes associated with a NSSS as expressed by Eqs. (31), (32) & (33). Examples of FCIs comprise FCI_{MSR}, FCI_{Power}, FCI_{Cond} (TC's Condenser), FCI_{RV}, FCI_{FW-HTX3} (feedwater heater #3), FCI_{HP} (HP turbine), FCI_{LP} (LP turbine), and the like. Item 650 is the computer program NUKE-MAX which employs routine matrix routines which solve NCV's four equations having four unknowns. These unknowns include the average neutron flux, electric power, the TC Condenser's heat rejection and RV coolant mass flow. Item 670, contained in NUKE-EFF, determines whether convergence criteria have been met, if not, the process returns for another Calculational Iteration which includes the matrix solution. If converged, the process proceeds to preparing reports of results, Item 680. Fundamentally, 680 reports comprise the set of verified Thermal Performance Parameters whereby an understanding of the system, and improvements to the system, may be achieved. Said reports detail a NSSS mass and energy balance, distribution of FCIs, First Law efficiencies, Second Law effectivenesses, and important verification results. Item 680 also distributes reports to system operators, engineers and regulatory authorities according to their needs and desires. Reports may take any form: paper, electronic, computer display, computer graphics and the like. Item 690 is to either quit, or return to Item 600 for another monitoring cycle. Typically when on-line, and at steady state, the NCV Method is exercised at a user selected time period, At, per Items 400 & 420 of FIG. 1 and FIG. 2. However, given the sensitivity of the reactivity feedback coefficient of Eq. (49), NUKE-EFF provides a “Reactor Dynamics” option where long data averaging is bypassed (i.e., from the typical 15 minute running averages), to 1 second or less as processed as straight data pass-thru. When the Reactor Dynamics option is invoked, NUKE-EFF continues with parallel processing its routine computations, using its standard running averages of data.

FIG. 5 is a detailed plot produced by PFP Model computations simulating a 1270 MWe PWR's reactor core. A cosine generated exergy rise produces a classic “sine-squared” shape; its Δg_{Core}/2 is found at y=72 inches. The Clausen Function, the Preferred Embodiment for the PFP, was produced from Eq. (48). Its peak was found at 47.134 inch for the 144.0 inch active core. Its peak's position from the core's entrance (FIG. 3 Item 330) is independent of neutron flux and reactor type; this location is also the DTL position. The Clausen's peak is greater than unity, see TABLE 2 for peak flux corrections.

Note that the Clausen Function, as formulated for the PFP Model, produces a zero flux at: y=−M_{T} (FIG. 3 Item 343), and at: y=2Z+M_{T} (FIG. 3 Item 347); for the PWR studied given M_{T}=6.6 cm (2.5984 inch); the distance 321 in FIG. 3. Half the core's exergy rise, Δg_{Core}/2, was found at y=80.5536 inches for the Clausen Function.

1. (canceled)

2. A method for adjusting operating parameters in a nuclear power plant comprising a core, a Reactor Vessel and a Turbine Cycle, wherein said adjusting includes Controlling Neutron Density causing changes in heat delivered to a Reactor Vessel coolant mass flow such that a Core Thermal Power produced by said plant does not exceed a Regulatory Limit, comprising the steps of:
formulating a calorimetric Model of the nuclear power plant consisting of a plurality of thermodynamic laws which solves for the average neutron flux, the Reactor Vessel coolant mass flow, a shaft power delivered to the electric generator and a heat rejection from the Turbine Cycle, the plurality of thermodynamic laws comprising:
formulating a Second Law balance of the nuclear power plant assuming nuclear fission is an inertial process comprising both a recoverable and an unrecoverable core Δexergy,
formulating a First Law balance of the nuclear power plant assuming nuclear fission is the inertial process comprising a conversion of the recoverable core Δexergy to a core Δenthalpy using an Inertial Conversion Factor,
formulating a First Law balance of the Turbine Cycle, and
formulating a Second Law balance of a Pseudo Fuel Pin assuming nuclear fission is the inertial process comprising both the recoverable and the unrecoverable core Δexergy, the PFP describing an average fuel pin in the core, the PFP comprising a theoretical, asymmetric, neutron flux profile which is partially integrated to a Differential Transfer Length (DTL);
acquiring a set of Off-Line Operating Parameters including the Regulatory Limit to the Core Thermal Power;
acquiring a set of On-Line Operating Parameters including a set of thermodynamic state properties of the Reactor Vessel's coolant;
using the calorimetric Model to determine a computed Reactor Vessel coolant mass flow based on the plurality of thermodynamic laws, the set of Off-Line Operating Parameters and the set of On-Line Operating Parameters;
determining a computed Core Thermal Power based on the computed Reactor Vessel coolant mass flow and the set of On-Line Operating Parameters; and
adjusting operating parameters by Controlling Neutron Density such that the computed Core Thermal Power does not exceed the Regulatory Limit.

3. The method of claim 2 after the step of formulating the Second Law balance of the Pseudo Fuel Pin, includes the additional steps of:
formulating a set of Verification Procedures, comprising:
determining a set of System Effects Parameters (SEP) and corresponding Reference SEP comprising the shaft power delivered to the electric generator,
determining a set of Choice Operating Parameters (COP) comprising a set of energy losses from the nuclear power plant, and
formulating a set of multidimensional minimization analyses which minimizes differences between the set of SEP and corresponding Reference SEP by adjusting the set of COP; and after the step of using the calorimetric Model to determine the computed Reactor Vessel coolant mass flow, includes the additional step of:
using the set of Verification Procedures to determine a verified Reactor Vessel coolant mass flow based on the computed Reactor Vessel coolant mass flow, the sets of SEPs and COPs, and the set of multidimensional minimization analyses; and wherein the step of determining the computed Core Thermal Power, includes
determining a verified Core Thermal Power based on the verified Reactor Vessel coolant mass flow and the set of On-Line Operating Parameters; and wherein the step of adjusting operating parameters, includes
adjusting operating parameters by Controlling Neutron Density such that the verified Core Thermal Power does not exceed the Regulatory Limit.

4.-24. (canceled)

25. A method for adjusting operating parameters in a nuclear power plant comprising a core, a Reactor Vessel and a Turbine Cycle, wherein said adjusting includes instigating operational changes based on a system understanding of the nuclear power plant, comprising the steps of:
before on-line operation:
acquiring a set of Off-Line Operating Parameters resulting in a Nuclear Model of the nuclear power plant,
acquiring a set of equations comprising nuclear and thermodynamic terms and a set of On-Line Operating Parameters comprising input to the set of equations resulting in a calorimetric Model of the nuclear power plant,
acquiring a set of System Effects Parameters (SEP) with a set of corresponding Reference SEPs resulting in a set of paired SEPs, and a method of minimizing differences between the paired SEPs by varying a set of Choice Operating Parameters (COP), resulting in a set of Verification Procedures of the nuclear power plant, and
acquiring a computer programmed with the Nuclear Model, the calorimetric Model and the set of Verification Procedures resulting in a programmed computer;
while operating on-line:
using the programmed computer to acquire a set of On-Line Operating Parameters,
using the programmed computer to process the calorimetric Model's equations based on the Nuclear Model and the set of On-Line Operating Parameters resulting in a thermodynamic solution of the nuclear power plant comprising thermal performance parameters,
using the programmed computer to verify the thermodynamic solution of the nuclear power plant based on the set of Verification Procedures resulting in a set of verified thermal performance parameters, and
quantifying the understanding of the nuclear power plant by reviewing the set of verified thermal performance parameters to instigate operational changes to the nuclear power plant which improves its performance.

26. The method of claim 25 wherein using the programmed computer to verify the thermodynamic solution of the nuclear power plant based on the set of Verification Procedures resulting in the set of verified thermal performance parameters, includes:
using the programmed computer to verify the thermodynamic solution of the nuclear power plant based on the set of Verification Procedures resulting in the set of verified thermal performance parameters which includes Fission Consumption Indices.

27. The method of claim 25 wherein using the programmed computer to verify the thermodynamic solution of the nuclear power plant based on the set of Verification Procedures resulting in the set of verified thermal performance parameters, includes:
using the programmed computer to verify the thermodynamic solution of the nuclear power plant based on the set of Verification Procedures resulting in the set of verified thermal performance parameters which includes Reactor Vessel coolant mass flow.

28. The method of claim 25 wherein using the programmed computer to verify the thermodynamic solution of the nuclear power plant based on the set of Verification Procedures resulting in the set of verified thermal performance parameters, includes:
using the programmed computer to verify the thermodynamic solution of the nuclear power plant based on the set of Verification Procedures resulting in the set of verified thermal performance parameters which includes Turbine Cycle feedwater mass flow.

29. The method of claim 25 wherein using the programmed computer to verify the thermodynamic solution of the nuclear power plant based on the set of Verification Procedures resulting in the set of verified thermal performance parameters, includes:
using the programmed computer to verify the thermodynamic solution of the nuclear power plant based on the set of Verification Procedures resulting in the set of verified thermal performance parameters which includes a set of First Law thermal efficiencies.

30. The method of claim 25 wherein using the programmed computer to verify the thermodynamic solution of the nuclear power plant based on the set of Verification Procedures resulting in the set of verified thermal performance parameters, includes:
using the programmed computer to verify the thermodynamic solution of the nuclear power plant based on the set of Verification Procedures resulting in the set of verified thermal performance parameters which includes a set of Second Law thermal effectivenesses.

31. The method of claim 25 wherein acquiring a set of equations comprising nuclear and thermodynamic terms and a set of On-Line Operating Parameters comprising input to the set of equations resulting in a calorimetric Model of the nuclear power plant, includes:
acquiring a set of equations comprising Second Law of thermodynamic principles comprising nuclear and thermodynamic terms and a set of On-Line Operating Parameters comprising input to the set of equations resulting in a calorimetric Model of the nuclear power plant.
